(19) United States
(12) Patent Application Publication
(10) Pub. No.: US 2019/0073830 A1
(43) Pub. Date: Mar. 7, 2019

(54) PROGRAM FOR PROVIDING VIRTUAL SPACE BY HEAD MOUNT DISPLAY, METHOD AND INFORMATION PROCESSING APPARATUS FOR EXECUTING THE PROGRAM

(71) Applicant: COLOPL, Inc., Tokyo (JP)

(72) Inventors: Shu FUJIMOTO, Tokyo (JP); Seiji SATAKE, Tokyo (JP)

(21) Appl. No.: 16/120,305

(22) Filed: Sep. 3, 2018

(30) Foreign Application Priority Data
Sep. 4, 2017 (JP) 2017-169602

(51) Int. Cl. G06T 19/00; G06T 13/40; G06F 3/01; G06Q 30/04; G06Q 30/06

(52) U.S. Cl. CPC G06T 19/006; G06T 13/40; G06F 3/013; G06T 2200/04; G06Q 30/04; G06Q 30/0643; G06F 3/012

(57) ABSTRACT

A method providing a virtual space according to at least one embodiment of this disclosure includes defining the virtual space, wherein the virtual space is associated with a first avatar object and a first virtual monitor object, and wherein the first avatar object is associated with a first user. The method further includes storing in a memory video content generated by photographing an event in real space. The method further includes storing in the memory information on a first virtual physical object associated with the video content in the memory. The method further includes reading the video content from the memory and displaying the read video content on the first virtual monitor object. The method further includes determining a first field of view of the first user in the virtual space based on a first virtual camera associated with the first avatar object. The method further includes displaying a first video corresponding to the first field of view on a head-mounted device of the first user. The method further includes arranging in the virtual space the first virtual physical object associated with the video content in response to advancement of processing of displaying the video content on the first virtual monitor object. The method further includes including in the field of view of the first user a notification prompting the first user to use the first virtual physical object in the virtual space.

### TECHNICAL FIELD

This disclosure relates to a technology of providing a virtual space, and more particularly, to a technology for enjoying in a virtual space an event to be performed in a real space.

### BACKGROUND ART

There is known public viewing of displaying various events such as sports and music concerts at movie theaters and the like. Public viewing has an advantage as to enable users to easily participate in an event even when the event venue is far away and to view the event on a large screen. However, there is a problem in that people at a venue, for example, a movie theater, may not be able to be sufficiently excited due to limitations on the actions that can be performed at the venue and worrying about what other people may feel about them.

To address such a problem, in recent years, there has been proposed a service that enables an event to be viewed on a large screen even at home by using a head-mounted display (Non-Patent Document 1).

### RELATED ART

### Non-Patent Documents

[Non-Patent Document 1] “idoga Live—360-degree Moving Image Real-time Live Distribution Service”, [online], [retrieved on Aug. 19, 2017], Internet (URL: http://www.idoga.jp/live/#events)

### SUMMARY

According to at least one embodiment of this disclosure, there is provided a method providing a virtual space, the method including: defining the virtual space, the virtual space being associated with a first avatar object and a first virtual monitor object, the first avatar object being associated with a first user; storing in a memory video content generated by photographing an event in a real space; storing in the memory information on a first virtual physical object associated with the video content; reading the video content from the memory and displaying the read video content on the first virtual monitor object; determining a first field of view of the first user in the virtual space based on a first virtual camera associated with the first avatar object; displaying a first video corresponding to the first field of view on a head-mounted device of the first user; arranging in the virtual space the first virtual physical object associated with the video content in response to advancement of processing of displaying the video content on the first virtual monitor object; and including in the field of view of the first user a notification prompting the first user to use the first virtual physical object in the virtual space.

The above-mentioned and other objects, features, aspects, and advantages of the disclosure may be made clear from the following detailed description of this disclosure, which is to be understood in association with the attached drawings.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of a detailed configuration of modules of the computer according to at least one embodiment of this disclosure.

FIG. 15 A diagram of an event developed in the virtual space according to at least one embodiment of this disclosure.

FIG. 16 A diagram of a field-of-view image visually recognized by the user according to at least one embodiment of this disclosure.

FIG. 17 A diagram of a field-of-view image at a time when a button is selected according to at least one embodiment of this disclosure.

FIG. 18 A block diagram of a hardware configuration and a module configuration of the server according to at least one embodiment of this disclosure.

FIG. 19 A table of an example of a data structure of a user DB according to at least one embodiment of this disclosure.

FIG. 20 A table of an example of a data structure of a video DB according to at least one embodiment of this disclosure.

FIG. 21 A table of an example of a data structure of a promotion DB according to at least one embodiment of this disclosure.

FIG. 22 A diagram of a field-of-view image visually recognized by the user according to at least one embodiment of this disclosure.

FIG. 23 A flowchart of processing of recommending a goods object to the user according to at least one embodiment of this disclosure.

FIG. 24 A flowchart of processing in which the processor transmits data on the user who is viewing an event to the server according to at least one embodiment of this disclosure.

FIG. 25 A table of an example of a data structure of a viewing history DB according to at least one embodiment of this disclosure.

FIG. 26 A flowchart of processing in which the server distributes a main video to the computer according to at least one embodiment of this disclosure.

FIG. 27 A flowchart of processing of translating motion of another past user in NPCs according to at least one embodiment of this disclosure.

FIG. 28 A diagram of a method of calculating a level of enthusiasm according to at least one embodiment of this disclosure.

FIG. 29 A diagram of an example of a special effect in the virtual space according to at least one embodiment of this disclosure.

FIG. 30 A flowchart of processing of executing a special effect in accordance with a level of enthusiasm according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

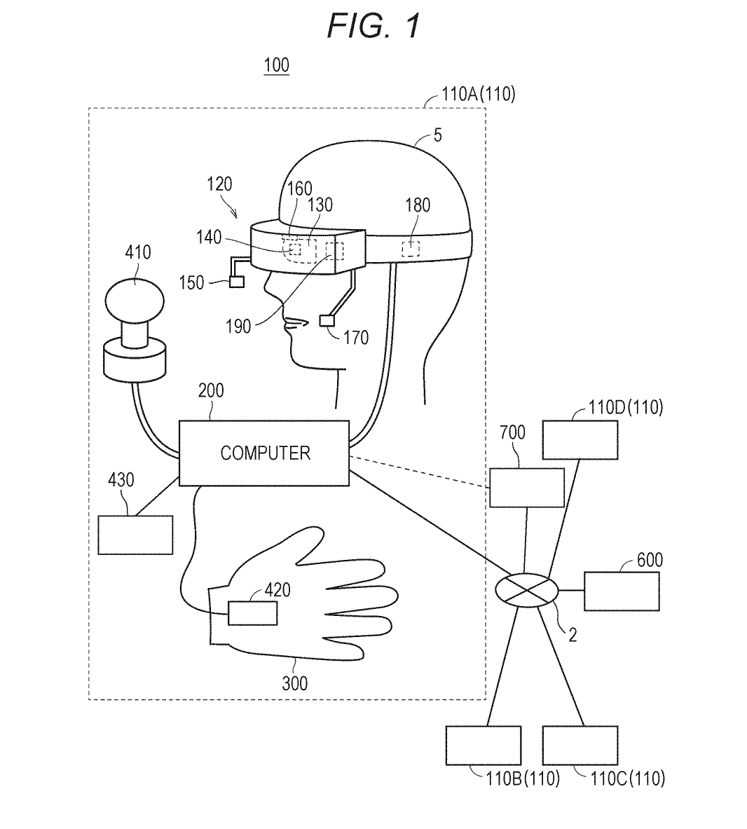

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

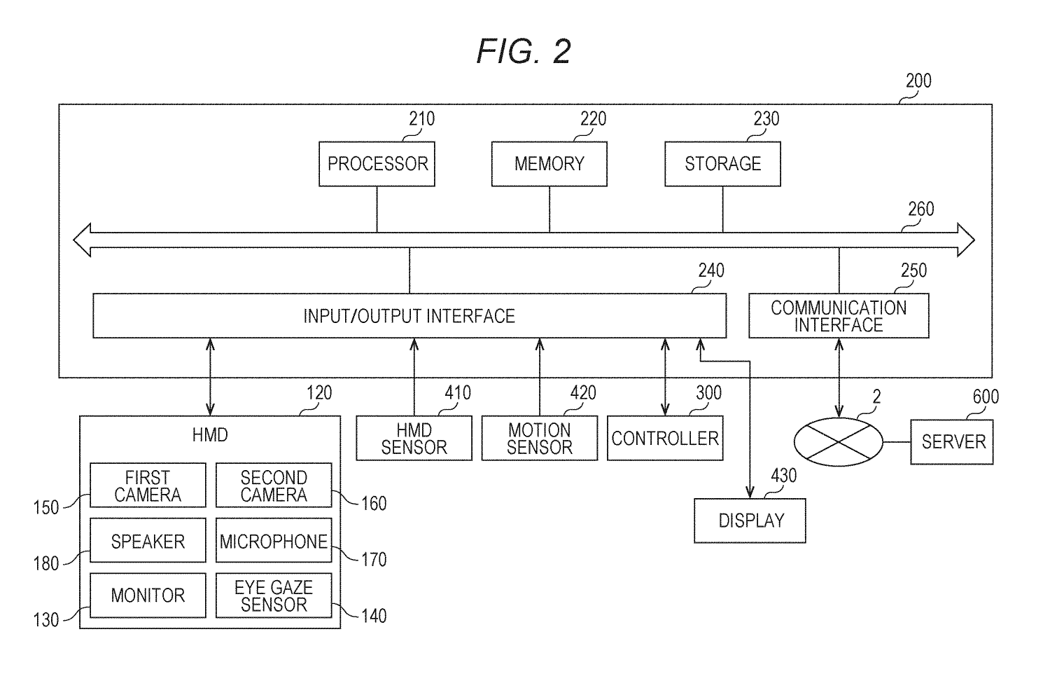

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth®, near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

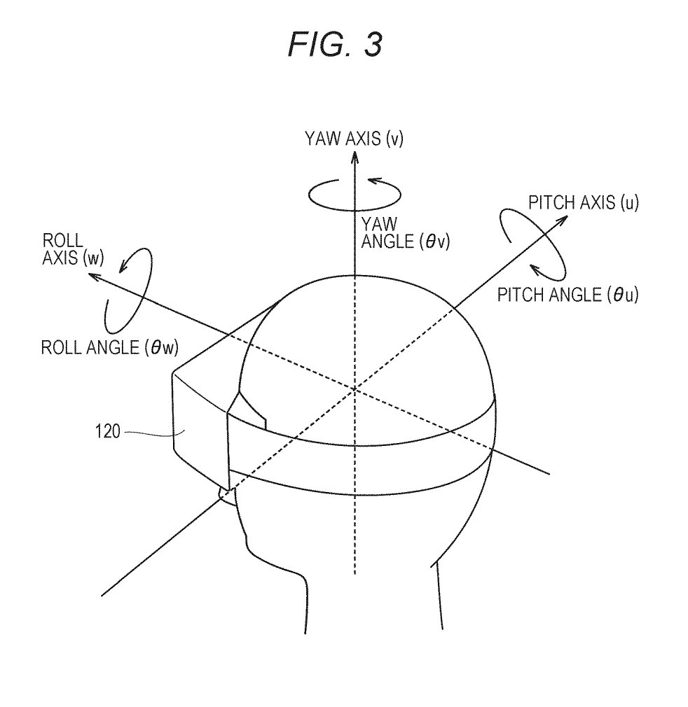

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

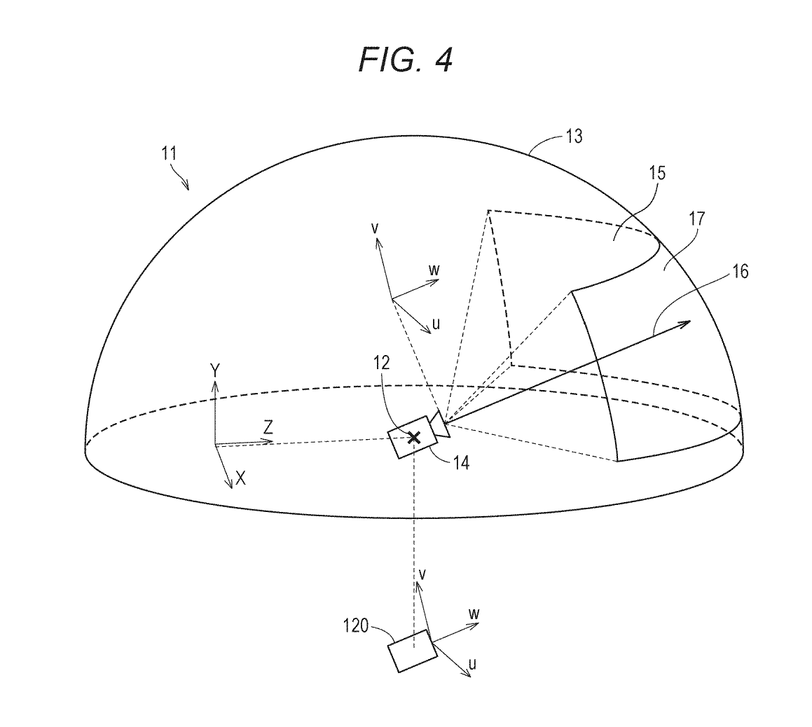

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

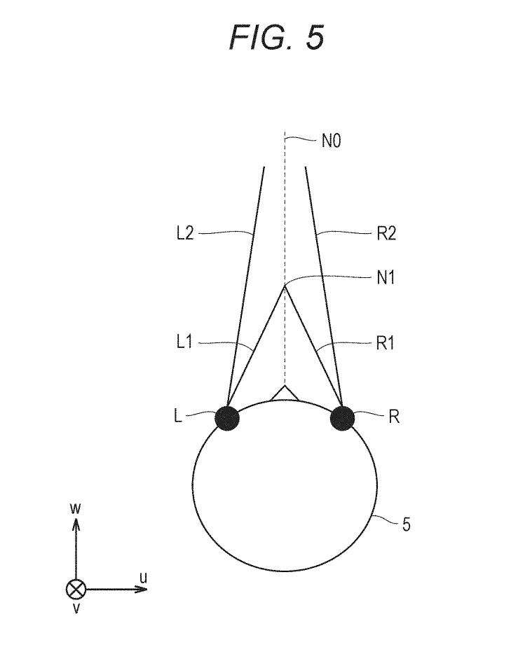

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight NO of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight NO. The line of sight NO is a direction in which the user 5 actually directs his or her lines of sight with both eyes. The line of sight NO corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

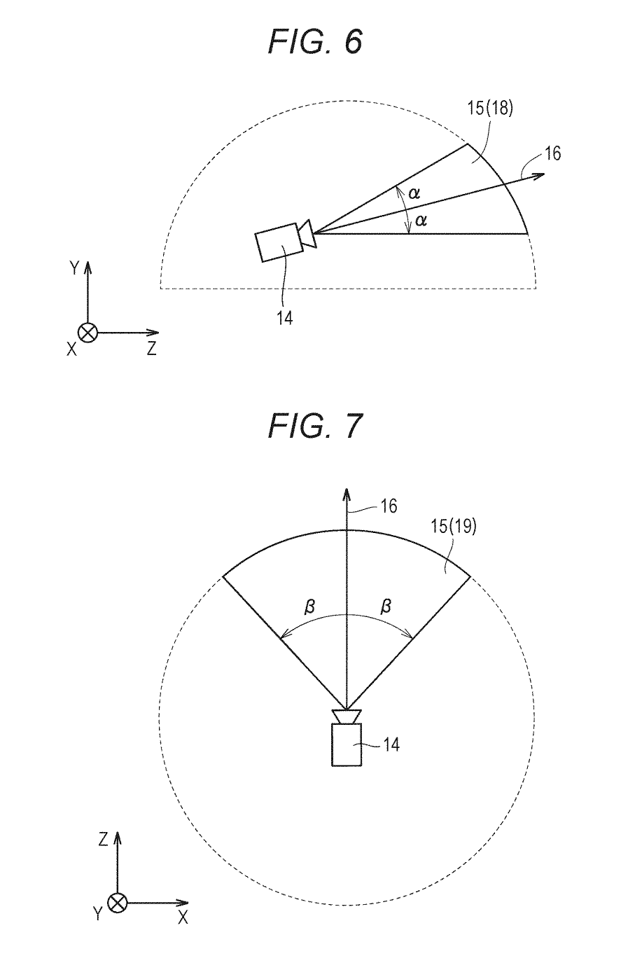

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth R from the reference line of sight 16 serving as the center in the virtual space 11 as the region 19. The polar angle α and (are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

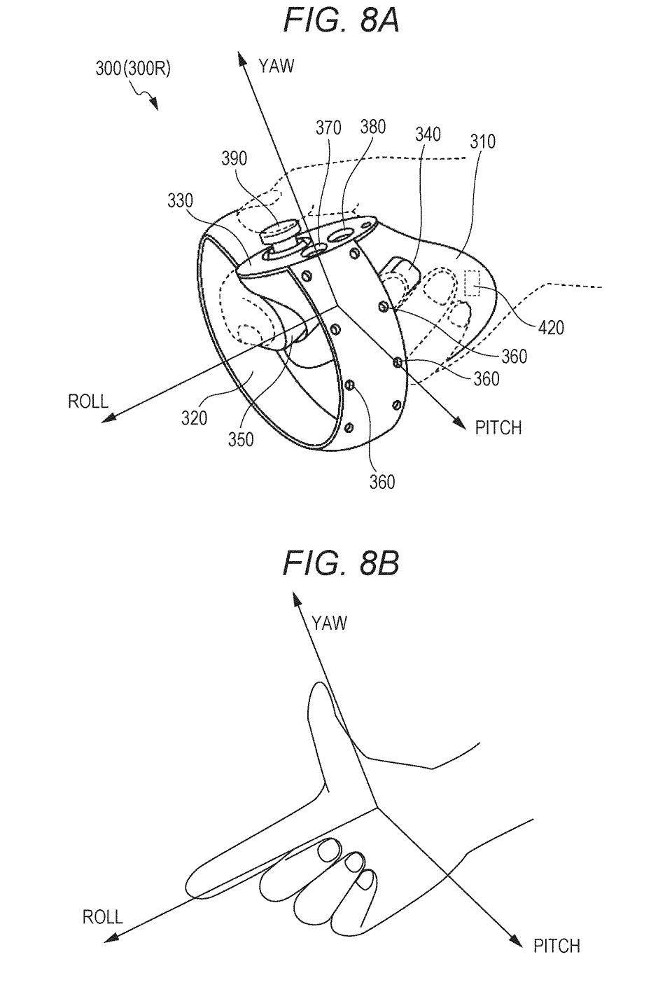

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

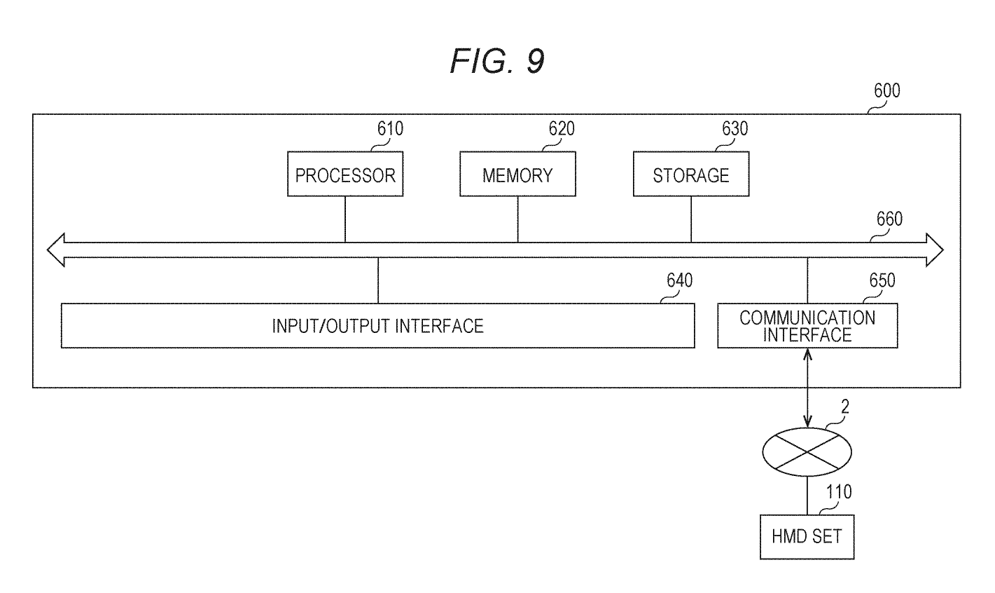

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

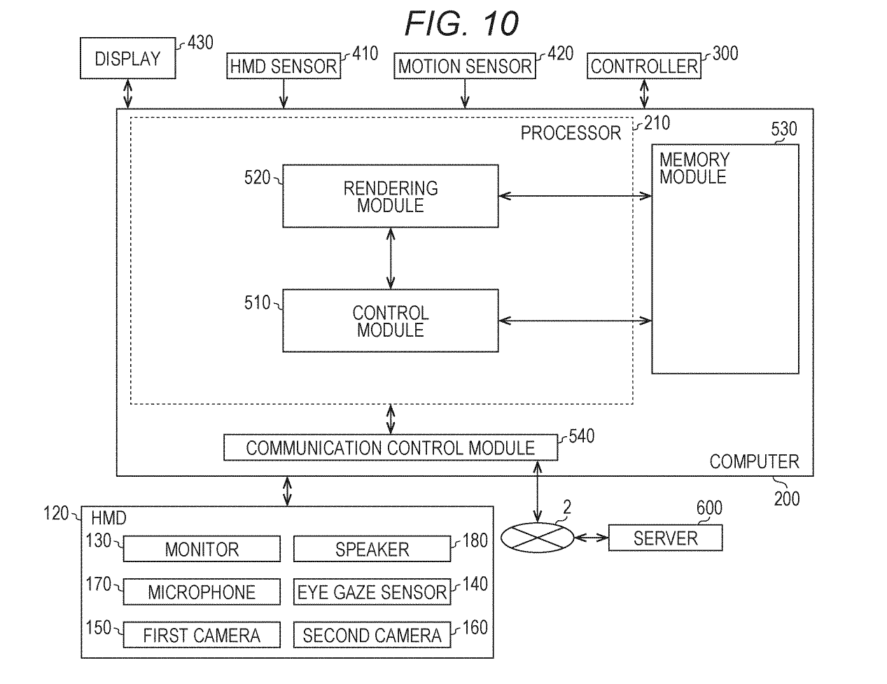

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity® provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

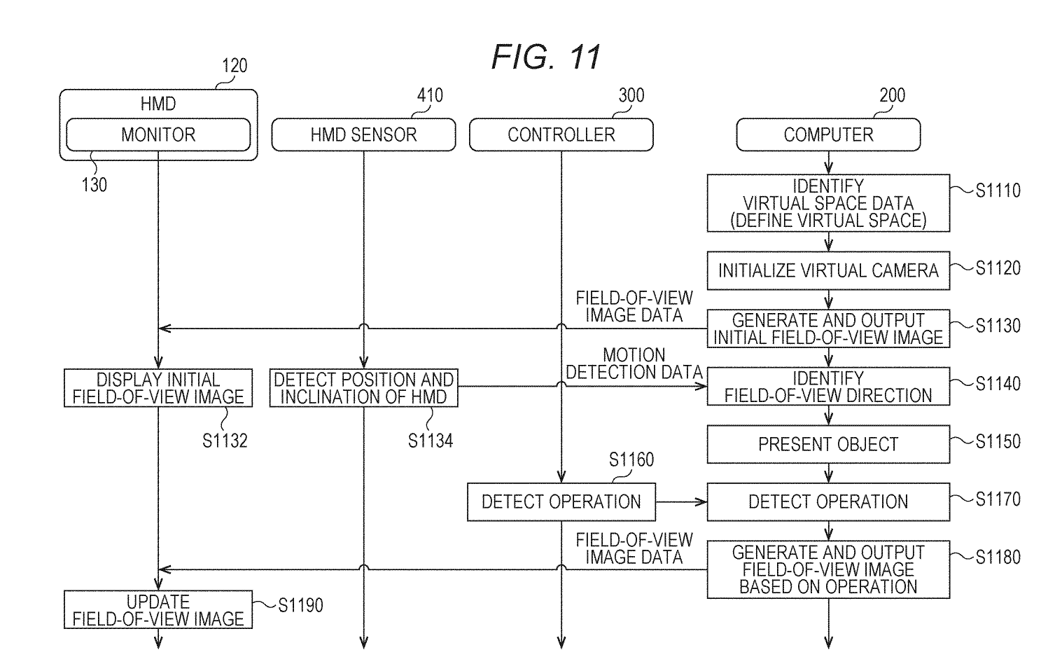

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

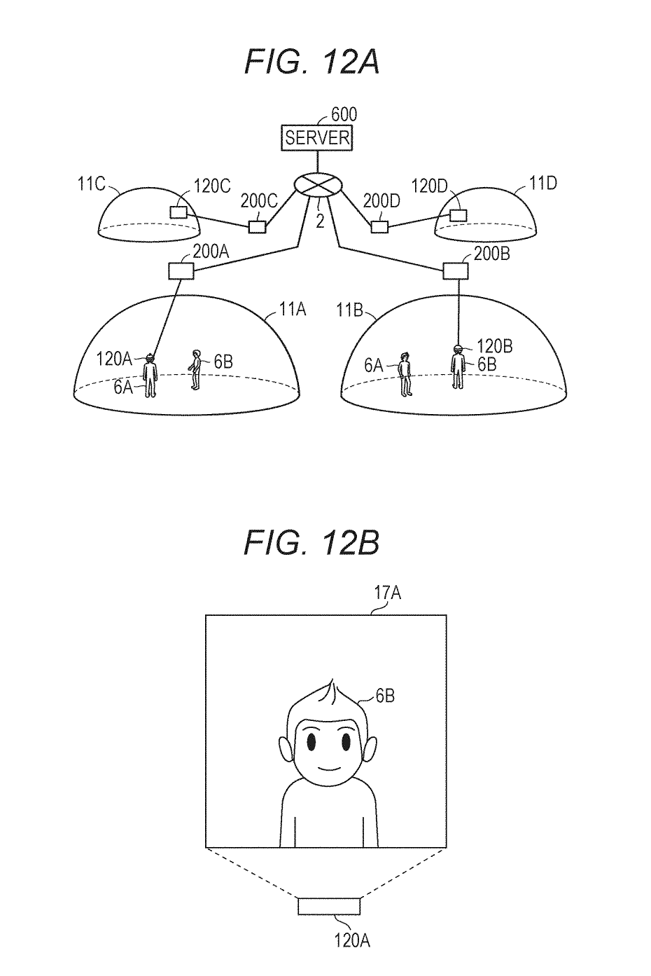

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

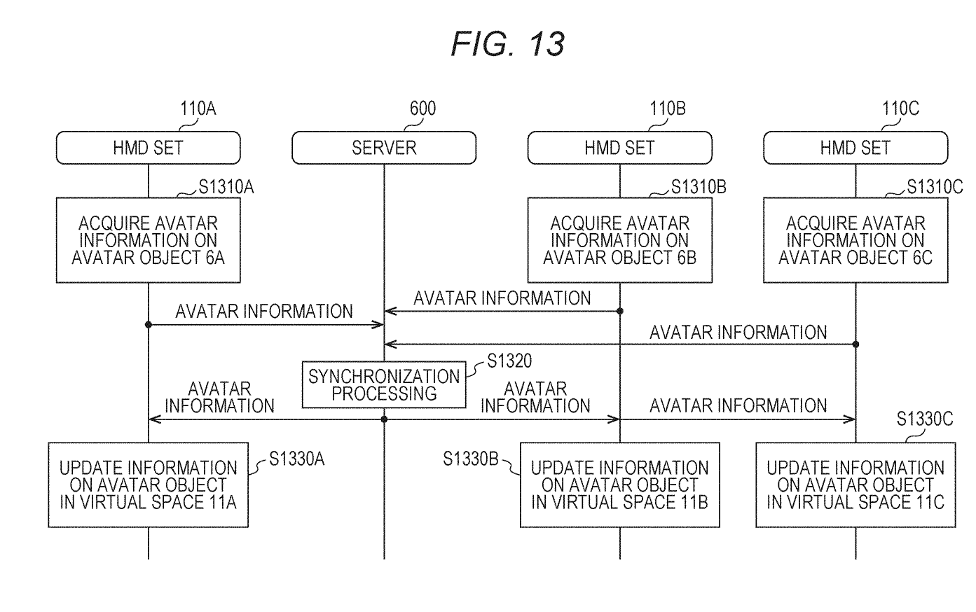

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Detailed Configuration of Modules]

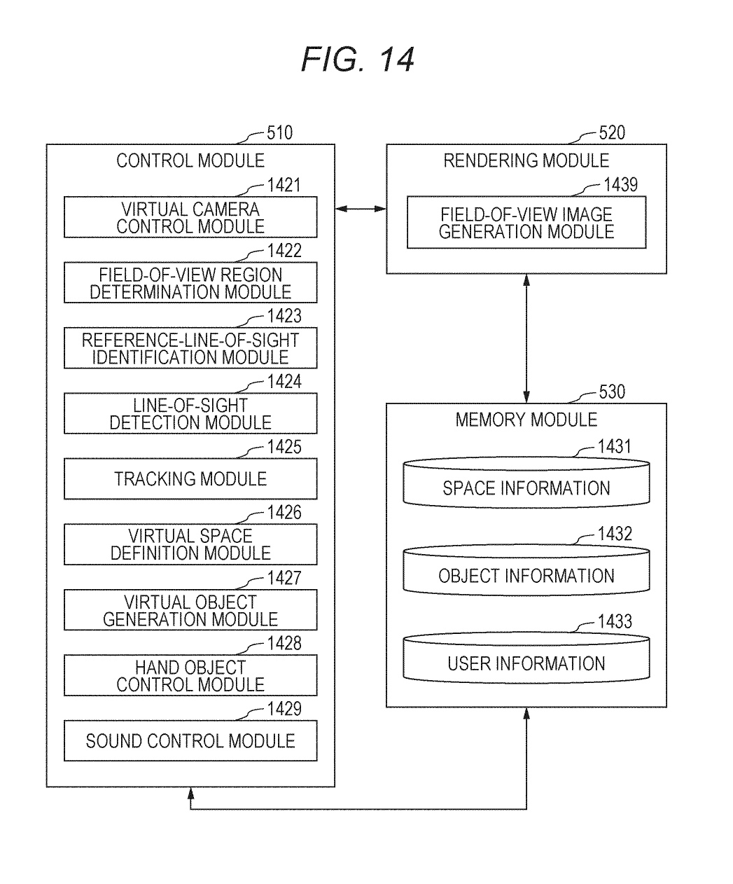

With reference to FIG. 14, details of a module configuration of the computer 200 are described. FIG. 14 is a block diagram of a detailed configuration of modules of the computer 200 according to at least one embodiment of this disclosure.

In FIG. 14, the control module 510 includes a virtual camera control module 1421, a field-of-view region determination module 1422, a reference-line-of-sight identification module 1423, a line-of-sight detection module 1424, a tracking module 1425, a virtual space definition module 1426, a virtual object generation module 1427, a hand object control module 1428, and a sound control module 1429. The rendering module 520 includes a field-of-view image generation module 1439. The memory module 530 stores space information 1431, object information 1432, and user information 1433.

In at least one aspect, the control module 510 controls image display on the monitor 130 of the HMD 120. The virtual camera control module 1421 arranges the virtual camera 14 in the virtual space 11, and controls the behavior, direction, and the like of the virtual camera 14. The field-of-view region determination module 1422 defines the field-of-view region 15 in accordance with the direction of the head of the user 5 wearing the HMD 120. The field-of-view image generation module 1439 generates data of the field-of-view image (also referred to as field-of-view image data) displayed on the monitor 130 based on the determined field-of-view region 15. The field-of-view image generation module 1439 also generates field-of-view image data based on data received from the control module 510. The field-of-view image data generated by the field-of-view image generation module 1439 is output to the HMD 120 by the communication control module 540. The reference-line-of-sight identification module 1423 detects a reference-line-of-sight (inclination of HMD 120) based on a signal from the HMD sensor 410 or the sensor 190. The line-of-sight detection module 1424 identifies a line of sight of the user 5 based on a signal from the eye-gaze sensor 140. The tracking module 1425 detects a motion of the controller 300 worn by the user 5, that is, the motion of the hand of the user 5. More specifically, the HMD sensor 410 detects infrared rays emitted by an infrared LED 35 arranged in the controller 300, and outputs the detected infrared rays to the computer 200. The tracking module 1425 detects the position of the controller 300 based on the detection result input from the HMD sensor 410.

The control module 510 controls the virtual space 11 provided to the user 5. The virtual space definition module 1426 defines the virtual space 11 in the HMD set 110 by generating virtual space data representing the virtual space 11.

The virtual object generation module 1427 generates data of the objects to be arranged in the virtual space 11. The objects may include, for example, other avatar objects, virtual panels, virtual letters, virtual mailboxes, and the like. The data generated by the virtual object generation module 1427 is output to the field-of-view image generation module 1439.

The hand object control module 1428 arranges a hand object in the virtual space 11. The hand object corresponds to, for example, the right hand or the left hand of the user 5 holding the controller 300. In at least one aspect, the hand object control module 1428 generates data for arranging in the virtual space 11 the hand object corresponding to the right hand or the left hand. The hand object control module 1428 generates data for moving the hand object in accordance with operation of the controller 300 by the user 5. The data generated by the hand object control module 1428 is output to the field-of-view image generation module 1439.

In at least one aspect, when a motion of a part of the body (e.g., motion of left hand, right hand, left leg, right leg, and head) of the user 5 is associated with the controller 300, the control module 510 generates data for arranging a partial object corresponding to the part of the user 5 in the virtual space 11. When the user 5 operates the controller 300 by using the part of the body, the control module 510 generates data for moving the partial object. Those pieces of generated data are output to the field-of-view image generation module 1439.

When an utterance due to use of the microphone 170 of the user 5 is detected from the HMD 120, the sound control module 1429 identifies the computer 200 to which the sound data corresponding to the utterance is to be transmitted. The sound data is transmitted to the computer 200 identified by the sound control module 1429. When the sound control module 1429 receives sound data from the computer 200 of another user via the network 2, the sound control module 1429 outputs from the speaker 180A sound (utterance) corresponding to the received sound data.

The space information 1431 stores one or more templates that are defined to provide the virtual space 11.

The object information 1432 stores content to be played back in the virtual space 11 and information for arranging the object to be used for that content. The content may include, for example, a game, content representing a landscape similar to real society, and the like. The object information 1432 also includes data for arranging in the virtual space 11 the hand object corresponding to the hand of the user 5 operating the controller 300, data for arranging in the virtual space 11 the avatar object of each user, and data for arranging in the virtual space 11 other objects, for example, a virtual panel.

The user information 1433 stores a program for causing the computer 200 to function as a control device of the HMD set 110, application programs using the various content stored in the object information 1432, and the like.

[Technical Concept]

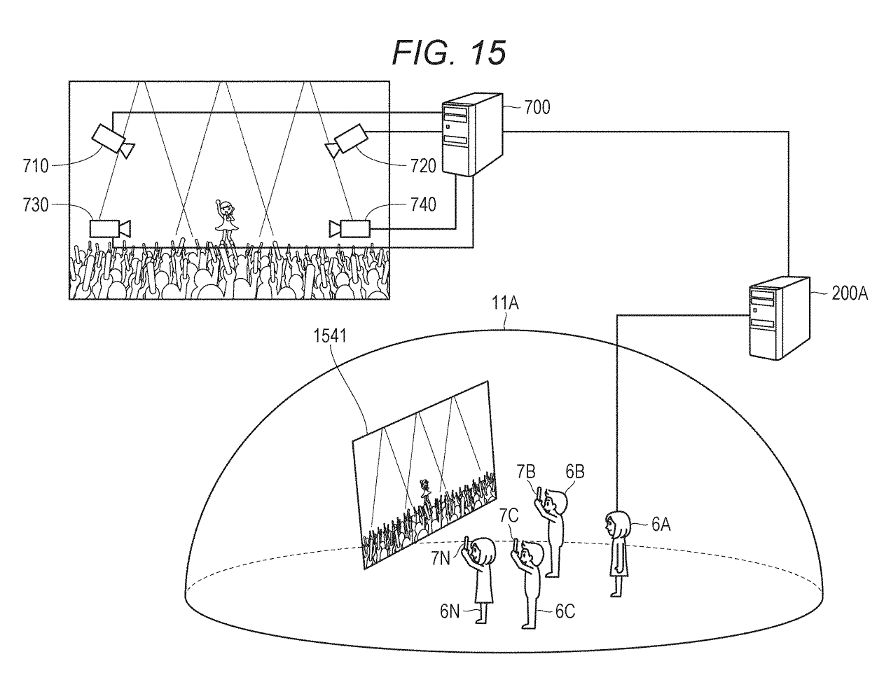

Next, the technical concept of at least one embodiment of this disclosure is described with reference to FIG. 15 to FIG. 17. FIG. 15 is a diagram of an event developed in the virtual space 11A according to at least one embodiment of this disclosure. Referring to FIG. 15, the virtual space 11A is defined by the processor 210A of the computer 200A.

The avatar object 6A corresponding to the user 5A, the avatar object 6B corresponding to the user 5B, the avatar object 6C corresponding to the user 5C, and an avatar object 6N are arranged in the virtual space 11A. The avatar objects 6B, 6C, and 6N each have light stick objects 7B, 7C, and 7N, respectively.

The computer 200A receives information representing the motion of each of the users 5B and 5C (e.g., motion of HMDs 120B and 120C or motion of controllers 300B and 300C) from the computers 200B and 200C. The processor 210A generates data for moving the avatar objects 6B and 6C based on the received information. For example, the processor 210A displays on the monitor 130A the avatar object 6B waving the light stick object 7B. As a result, the user 5A is able to recognize the motion in the real space of each of the users 5B and 5C via the avatar objects 6B and 6C. The avatar object 6N is a non-player character that is not operated by any one of the users. The avatar object 6N performs a motion determined in advance.

The virtual camera 14A is arranged at the eye position of the avatar object 6. As a result, the user 5A can share the field of view of the avatar object 6A. In the example of FIG. 15, the user 5A is visually recognizing a main screen 1541 arranged in the virtual space 11A. The main screen 1541 displays events performed in the real space. The events include, for example, live music, sports, theater performances, and the like.

The external device 700 functions as a video distribution server and includes cameras 710 to 740. The cameras 710 to 740 may be fixed or movable. More specifically, the cameras 710 to 740 arranged in the external device 700 are arranged at positions different from each other in the event venue to photograph the event. The external device 700 transmits the image photographed by the cameras 710 to 740 to the computer 200A. The processor 210A displays the image received from the external device 700 on the main screen 1541. With this, the user 5A can enjoy the event in the virtual space 11A without going to the venue at which the event is being performed.

In general, the enjoyment felt by the user regarding an event depends on the distance between the event performer and the user (in other words, seat assigned to the user). In regard to this, the user 5A can visually recognize the performer displayed in a large size on the main screen 1541. Therefore, the user 5A may enjoy the event more.

There are some users who want to cheer the performer in a loud voice during the event and move their body around a lot, but refrain from doing so because the users are worried about what other people may feel about them. In regard to this, through use of the HMD set 110A in a space in which there are no other people, the user 5A can perform the actions that he or she wants to without worrying about what other people may feel about him or her. With this, the user 5A has a greater feeling of participating in the event, and as a result, the user 5A can enjoy the event more.

Tickets for popular events performed in the real space are difficult to obtain. In contrast, because there are no place restrictions in the virtual space, the user 5A can easily obtain a ticket for an event performed in virtual space. The promoter can sell tickets for an event to people who were not able to participate in events until now due to problems involving ticket acquisition, distance, and the like.

Through visual recognition of the avatar objects 6B, 6C, and 6N that are expressing a reaction to the event, the user 5A is able to feel a sense of participation in the event, a feeling of being at the event, and a feeling of togetherness with the other audience members (users 5B, 5C, and people viewing the event in real space).

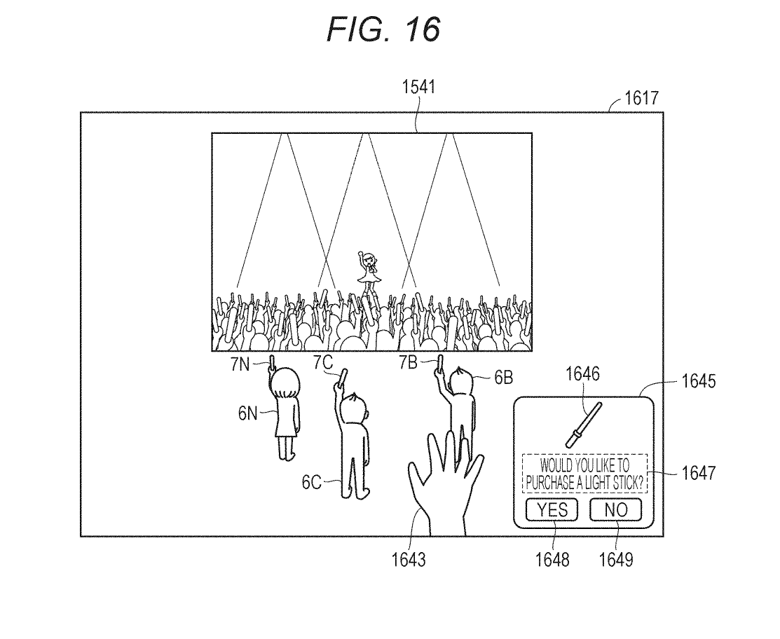

FIG. 16 is a diagram of a field-of-view image 1617 visually recognized by the user 5A according to at least one embodiment of this disclosure. The field-of-view image 1617 includes a hand object 1643. The processor 210A of the computer 200A translates the motion of the controller 300A (i.e., motion of the hand of user 5A) in the hand object 1643. More specifically, the processor 210A serves as the tracking module 1425A to detect the position of the controller 300A with respect to the HMD sensor 410A based on the result of detecting, by the HMD sensor 410A, infrared rays emitted from the controller 300A. The hand object control module 1428A moves the hand object 1643 based on a difference between the detected position with respect to the position of the controller 300A detected at the time of calibration.

In the field-of-view image 1617, the avatar objects 6B, 6C, 6N are each waving a light stick object 7B, 7C, or 7N, respectively. A state in which a person participating in an event in the real space is waving a light stick is displayed on the main screen 1541.

In such a situation, the user 5A thinks that he or she also wants to wave the light stick in the virtual space 11A to obtain a sense of togetherness with other audience members. Therefore, in at least one aspect, the processor 210A prompts the user 5A to prepare a light stick object so as to enable the user 5A to use the light stick object in the virtual space 11A.

As an example, the processor 210A arranges a popup 1645 in the virtual space 11A. The popup 1645 includes a light stick 1646, a message 1647, and buttons 1648 and 1649. The message 1647 is a question asking the user 5A whether an object corresponding to the light stick 1646 (light stick object) is arranged in the virtual space 11A. As an example, the popup 1645 includes the message 1647 “Would you like to purchase a light stick?” The buttons 1648 and 1649 are interfaces for receiving a response from the user 5A to the question in the message 1647. More specifically, the button 1648 functions as an interface for affirmatively responding to the question of the message 1647, and the button 1649 functions as an interface for negatively responding to the question of the message 1647. The user 5A selects one of the buttons by causing the hand object 1643 to touch the button 1648 or the button 1649.

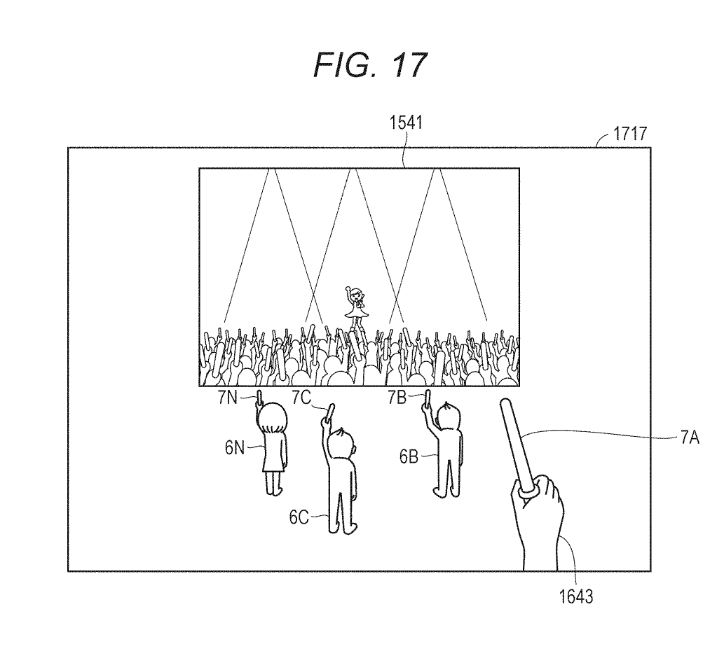

FIG. 17 is a diagram of a field-of-view image 1717 at a time when the button 1648 is selected according to at least one embodiment of this disclosure. In response to the pressing of the button 1648, the processor 210A arranges a light stick object 7A in the virtual space 11A. More specifically, the processor 210A arranges the light stick object 7A in association with the hand object 1643. With this, the light stick object 7A moves in association with the hand object 1643.

Therefore, when the user 5A waves the controller 300A, that is, when he or she waves his or her hand, a field-of-view image in which the hand object 1643 is waving the light stick object 7A is provided to the user 5A. As a result, the user 5A can enjoy the event more, because the user 5A feels a sense of participation in the event and a sense of togetherness with the other audience members.

In response to the pressing of the button 1648, the processor 210A executes processing of billing the user 5A for the amount of money of the light stick object 7A.

It is only required for the processor 210A to prompt the user 5A to prepare the goods object corresponding to the goods to be used in the event so as to enable the user 5A to use the goods object. The processor 210A may also recommend to the user 5A a goods object other than a light stick object.

In this way, the HMD set 110A not only provides video of the event to the user 5A, but also enhances the sense of participation of the user 5A in the event by ensuring that the user 5A can use the goods object to be used in the event. The detailed processing for recommending the goods object to the user is now described below.

[Server Configuration]

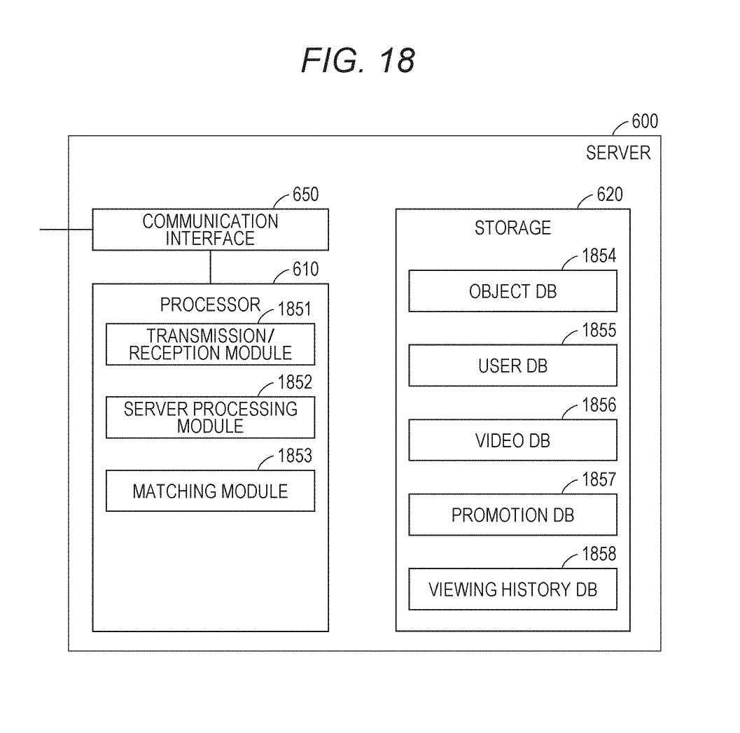

FIG. 18 is a block diagram of a hardware configuration and a module configuration of the server 600 according to at least one embodiment of this disclosure. The server 600 includes a communication interface 650, a processor 610, and a storage 630 as main hardware.

The communication interface 650 functions as a communication module for wireless communication that performs modulation and demodulation processing and the like for transmitting and receiving signals to/from external communication devices such as the computer 200 and the external device 700. The communication interface 650 is implemented by a tuner, a high frequency circuit, or the like.

The processor 610 controls the operation of the server 600. The processor 610 functions as a transmission/reception module 1851, a server processing module 1852, and a matching module 1853 by executing various control programs stored in the storage 630.

The transmission/reception module 1851 transmits and receives various information to/from each computer 200. For example, the transmission/reception module 1851 transmits to each computer 200A a request to arrange an object in the virtual space 11, a request to delete an object from the virtual space 11, a request to move an object, a sound of the user, and information for defining the virtual space 11.

The transmission/reception module 1851 receives from the external device 700, for example, video data of an event photographed by the cameras 710 to 740 and information (event ID) identifying the event. The received video data is stored in a video DB 1856, which is described later. In response to a request from the computer 200, the transmission/reception module 1851 distributes the video data stored in the video DB 1856 to the requesting computer 200. As a result, the user 5 of the computer 200 is able to experience in the virtual space 11 an event performed in the past.

The server processing module 1852 updates various databases stored in the storage 630 based on information received from the computer 200 or the external device 700.

The matching module 1853 performs a series of processing steps for associating a plurality of users with one another. For example, when a plurality of users have performed an input operation for sharing the same event (virtual space 11), the matching module 1853 performs processing of associating the user IDs (identification) of the plurality of users with one another.

The storage 630 includes an object DB 1854, a user DB 1855, a video DB 1856, a promotion DB 1857, and a viewing history DB 1858.

The object DB 1854 contains the data required for rendering various objects (for example, light stick object). In at least one aspect, the object DB 1854 stores rendering data of the object and information (object ID) for identifying the object in association with each other. When an object ID is received from the computer 200, the processor 610 transmits the rendering data corresponding to the object ID to the receiving computer 200.

The user DB 1855 contains information (user ID) for identifying the user of each HMD set 110 connected to the network 2 and attribute information on the users. The video DB 1856 contains video data of events photographed by the cameras 710 to 740. The promotion DB 1857 includes the events and the goods to be used in the events (object ID of corresponding goods object). The viewing history DB 1858 contains data representing the behavior of the users who are viewing the event (e.g., where they are looking at). The data structure of each of the user DB 1855, the video DB 1856, the promotion DB 1857, and the viewing history DB 1858 is described in detail below.

(User DB)

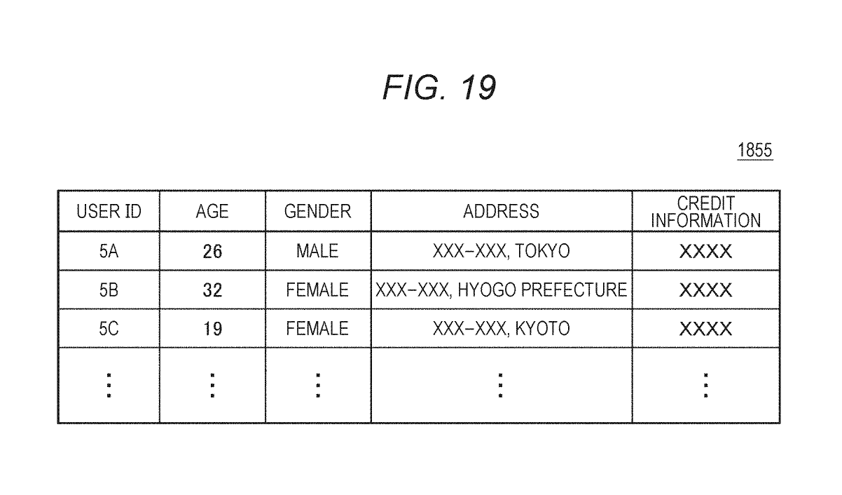

FIG. 19 is a table of an example of a data structure of the user DB 1855 according to at least one embodiment of this disclosure. The user DB 1855 stores a user ID, age, gender, address, and credit information in association with one another. The credit information may include the number and the security code of the credit card used by the relevant user 5 and information on the issuer of the credit card. The user 5 registers his or her age, gender, address, and credit information in the server 600 in advance.

(Video DB 1856)

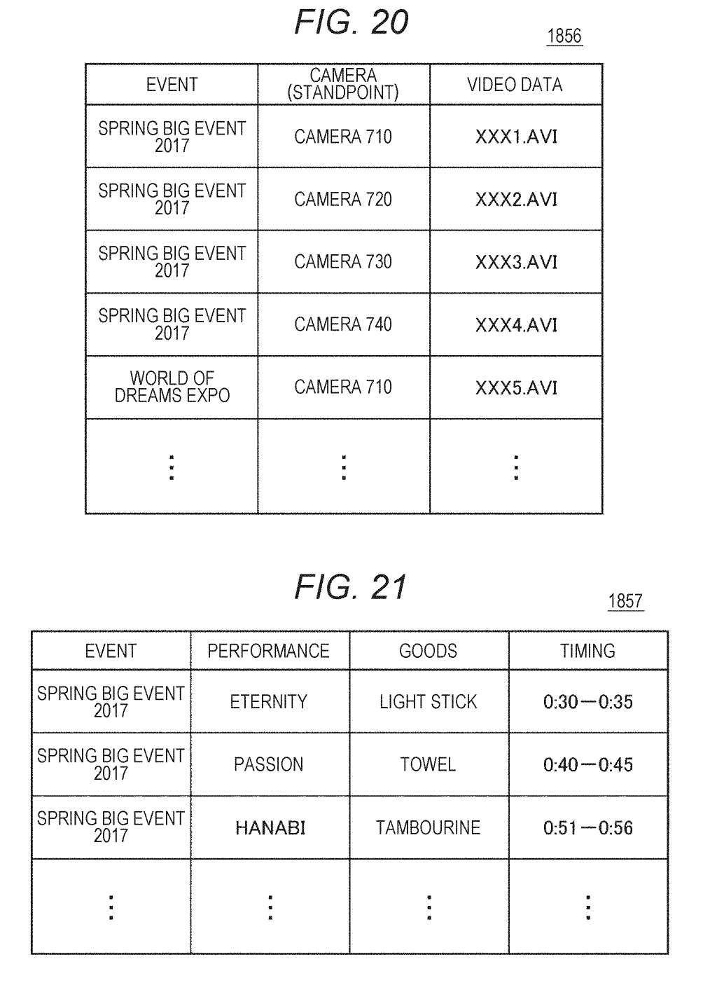

FIG. 20 is a table of an example of a data structure of the video DB 1856 according to at least one embodiment of this disclosure. The video DB stores information identifying the event, information identifying the cameras 710 to 740 (in other words, information identifying the position (standpoint) from which the event is seen), and video data in association with one another. In the example of FIG. 20, the video DB 1856 stores the video data “XXX1.AVI” generated by photographing “Spring Big Event 2017” with “Camera 710”.

(Promotion DB)

FIG. 21 is a table of an example of a data structure of the promotion DB 1857 according to at least one embodiment of this disclosure. The promotion DB 1857 stores information identifying the event, performances to be performed in the event, goods (object IDs of corresponding goods objects) to be used in the performances, and the timing at which each performance is to be performed after the event starts in association with each other. For example, when the event is a live music event, the performances may be each song. As another example, when the event is live boxing, the performances may be each fight. In this way, the event includes one or more performances. In at least one of the one or more performances, goods corresponding to the performance are used in the event. In the example of FIG. 21, it can be read that a “towel” is to be used in the performance “Passion” of the event “Spring Big Event 2017”, and that the performance is to be performed between “40 minutes to 45 minutes” after the start of the event.

Each piece of data included in the promotion DB is registered in advance by the promoter before the event is held in the real space.

[Main Screen and Subscreens]

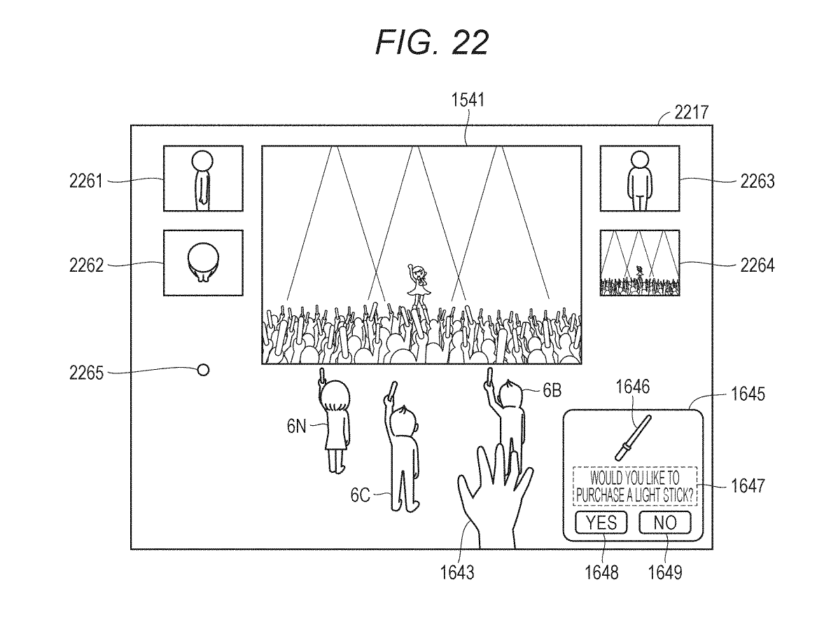

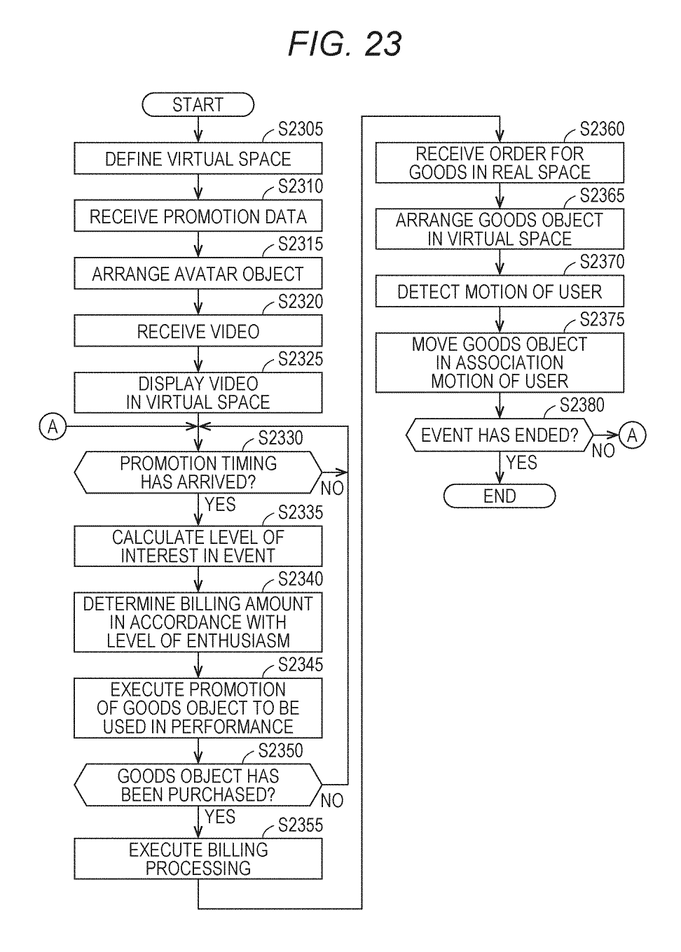

Next, with reference to FIG. 22, there is described a method of providing an event in the virtual space according to at least one embodiment of this disclosure. FIG. 22 is a diagram of a field-of-view image 2217 visually recognized by at least one user 5A according to at least one embodiment of this disclosure. The field-of-view image 2217 is substantially the same as the field-of-view image 1617 of FIG. 16, and hence only the portions that are different are described here.

The field-of-view image 2217 includes subscreens 2261 to 2264. The subscreens 2261 to 2264 are smaller than the main screen 1541. When video data corresponding to the cameras 710 to 740 is received from the external device 700, the processor 210A outputs the video data to the subscreens 2261 to 2264. More specifically, the subscreen 2261 displays the image generated by the camera 710 photographing the event. The subscreen 2262 displays the image generated by the camera 720. The subscreen 2263 displays the image generated by the camera 730. The subscreen 2264 displays the image generated by the camera 740.

A pointer object 2265 represents a viewpoint of the user 5A in the virtual space 11A. The processor 210A serves as a line-of-sight detection module 1424A to detect the line of sight of the user 5A in the real space based on output of an eye-gaze sensor 140A. The line-of-sight detection module 1424A converts the line of sight of the user 5A in the real space into a line of sight in the virtual space 11A based on the position and inclination (reference-line-of-sight) of the virtual camera 14A. A virtual object generation module 1427A arranges the pointer object 2265 at the position where the line of sight in the virtual space 11A and the object collide with each other.

In at least one aspect, of the images displayed on the subscreens 2261 to 2264, the user 5A feels that he or she wishes to view the video displayed on the subscreen 2264 on a large screen. In that case, the user 5A selects the subscreen 2264. As an example, the user 5A selects the subscreen 2264 by superimposing the pointer object 2265 on the subscreen 2264 for a predetermined period of time (e.g., 2 seconds). As another example, the user 5A selects the subscreen 2264 by superimposing a light beam extending from the tip of the hand object 1643 on the subscreen 2264 for a predetermined period of time. When the processor 210A detects that the subscreen 2264 has been selected by the user 5A, the processor 210A displays the video corresponding to the subscreen 2264 (video generated by camera 740) on the main screen 1541. As a result, the user 5A can view the video he or she is interested in on a large screen.

In the above-mentioned example, the processor 210A is configured to display the video of the event on screens arranged in advance in the virtual space 11A, but the display method of the event is not limited thereto. For example, the processor 210A may display the video of the event on a celestial sphere forming the virtual space 11A. This enables the user 5A to enjoy the event in a more immersive manner. In such a case, the cameras provided in the external device 700 are configured to be able to photograph a panorama image.

In the example of FIG. 17, the avatar object 6A is holding a light stick object 7A. In at least one aspect, the processor 210A changes the light stick object 7A to another object in accordance with an instruction from the user 5A. For example, the processor 210A changes the light stick object 7A to a fish object. This enables the user 5A to enjoy an out-of-the-ordinary feeling in the virtual space 11A that normally is not possible.

[Processing of Recommending Goods Object]

FIG. 23 is a flowchart of processing of recommending a goods object to the user 5A according to at least one embodiment of this disclosure. The processing of FIG. 23 is implemented by the processor 210A executing various control programs stored in the memory 11 or the storage 230.

In Step S2305, the processor 210A serves as the virtual space definition module 1426A to define the virtual space 11A. In Step S2310, the processor 210A transmits to the server 600 information (event ID) identifying the event selected by the user 5A. The server 600 refers to the promotion DB 1857 and transmits to the computer 200A data of the performance corresponding to the event ID, the object ID of the goods object corresponding to the goods to be used in the performance, the timing at which the performance is to be performed, and the like. The processor 210A receives those pieces of information (promotion data).

In Step S2315, the processor 210A arranges the avatar object 6A corresponding to the user 5A in the virtual space 11. The processor 210A further arranges in the virtual space 11A the avatar objects 6B and 6C corresponding to the other users 5B and 5C participating in the event. More specifically, the processor 210A receives the rendering data of the avatar objects 6B and 6C, or information for identifying the rendering data and position information, and arranges the avatar objects based on those pieces of information. The processor 210A periodically (e.g., 60 times per second) receives position information and motion information on the avatar objects 6B and 6C (e.g., position information on HMD 120B and position information on controller 300B) from the server 600, and translates those pieces of information in the avatar objects 6B and 6C. The processor 210A further arranges in the virtual space 11A the avatar object 6N as a non-player character.

In Step S2320, the processor 210A receives video data of the event from the external device 700. In Step S2325, the processor 210A displays the received video of the event on the screens arranged in the virtual space 11A. As an example, the processor 210A displays video data streamed and distributed from the external device 700 on the screens as required. As a result, the user 5A may enjoy the event in the virtual space 11A in real time.

In Step S2330, the processor 210A determines whether the promotion timing has arrived. For example, when the elapsed time from the start of the event reaches the timing indicated by the promotion data received in Step S2310, the processor 210A determines that the promotion timing has arrived. As a result, the processor 210A may determine that the promotion timing has arrived when the performance displayed on the screens in the virtual space 11A is a predetermined performance (performance represented by promotion data).

In at least one aspect, the processor 210A determines that the promotion timing has arrived at a predetermined time before (e.g., 10 seconds before) the timing at which a performance determined in advance is displayed on the screens (timing indicated by the promotion data). With this configuration, the user 5A can concentrate more on the performance, and as a result enjoy the event more.

When it is determined that the promotion timing has arrived (YES in Step S2330), the processor 210A executes the processing of Step S2335. Otherwise (NO in Step S2330), the processor 210A waits until the promotion timing arrives.

In Step S2335, the processor 210A calculates the level of interest (hereinafter also referred to as “level of enthusiasm”) of the user 5A in the event. In at least one embodiment, the processor 210A calculates the level of enthusiasm based on the behavior of the user 5A for a predetermined period of time. For example, the predetermined period of time is set to a certain period of time (e.g., 5 seconds), or a period of time from the start of the event to the present.

As an example, the processor 210A calculates the level of enthusiasm by using at least one of: a cumulative value of the acceleration of the HMD 120 (i.e., motion of head of user 5A) for a predetermined period of time; a cumulative value of the acceleration of the controller 300 (i.e., motion of hand of user 5A); or a cumulative value of the amplitude of a sound signal output from the microphone 119. The processor 210A calculates the level of enthusiasm such that the level of enthusiasm becomes higher when those parameters are larger.

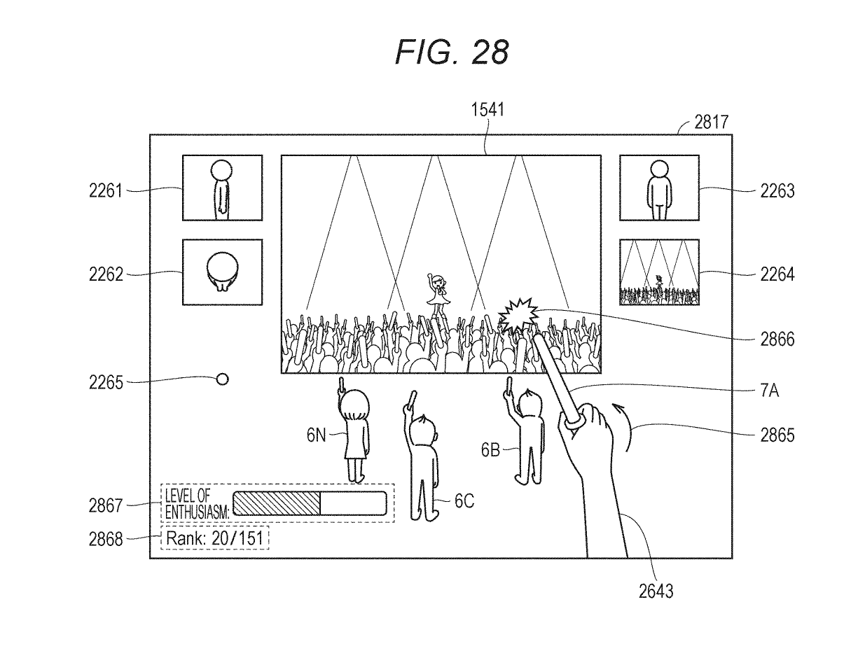

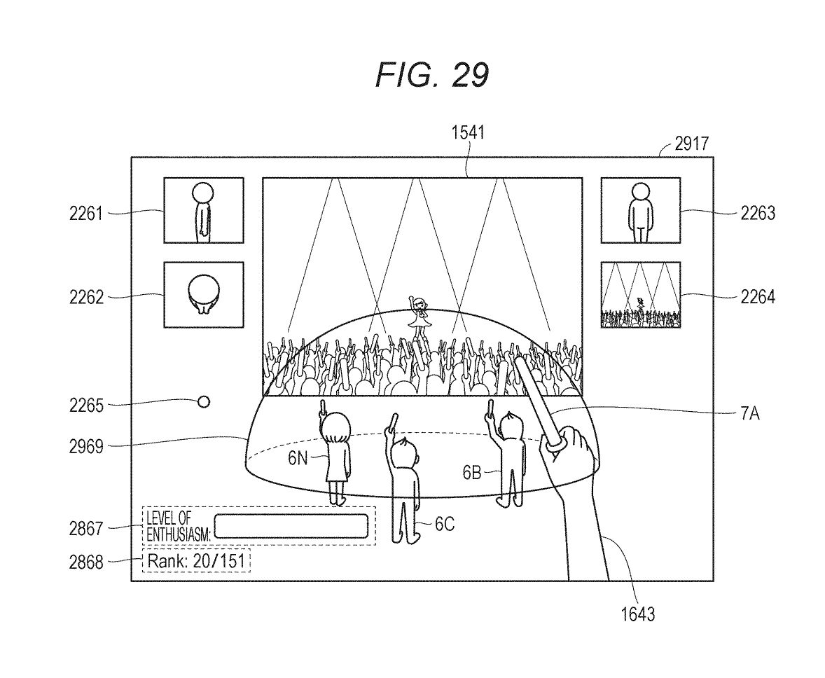

As another example, the processor 210A calculates the level of enthusiasm based on a facial expression of the user 5A for a predetermined period. More specifically, the processor 210A periodically acquires (e.g., 30 times per second) a face image of the user 5A generated by a camera (not shown) (e.g., camera arranged in HMD 120). The processor 210A detects a feature amount (e.g., position of corner of mouth and eye size) from the face image, and calculates a difference from the feature amount detected from the reference image. The reference image is a face image of a neutral facial expression of the user 5A. The processor 210A calculates the level of enthusiasm such that the level of enthusiasm increases when the cumulative value of the difference for a predetermined period of time increases. Another method of calculating the level of enthusiasm is described with reference to FIG. 28.

In Step S2340, the processor 210A determines a billing amount in accordance with the calculated level of enthusiasm. More specifically, the processor 210A determines the billing amount such that the billing amount is lower when the calculated level of enthusiasm is higher.

In Step S2345, regarding the goods object corresponding to goods for the performance that is currently displayed or is to be displayed in the virtual space, the processor 210A prompts the user 5A to prepare that goods object so as to enable the user 5A to use the goods object in the virtual space 11A. As an example, the processor 210A arranges the popup 1645 of FIG. 16 and FIG. 22 in the virtual space 11A. As another example, processor 210A may recommend a goods object to the user 5A by using sound. As an example, in such processing, the processor 210A asks the user 5A whether he or she wishes to purchase the goods object. At this time, the processor 210A notifies the user 5A of the billing amount determined in Step S2340.

In Step S2350, the processor 210A receives input of the response of the user 5A to the processing of Step S2345. The processor 210A determines whether the response is an affirmative response to purchase the goods object. When an affirmative response to purchase the goods object is input (YES in Step S2350), the processor 210A executes the processing of Step S2355. Otherwise (NO in Step S2350), the processor 210A again executes the processing of Step S2330.

In Step S2355, the processor 210A executes processing of billing the user 5A for the cost of the goods object. Specifically, the processor 210A transmits the billing amount determined in Step S2340 and the user ID of the user 5A to the server 600. The processor 610 of the server 600 refers to the user DB 1855, and acquires credit information corresponding to the received user ID. The server 600 transmits credit information (e.g., credit card number, security code, owner of credit card, and billing amount) required for settlement to the issuer of the credit card (i.e., the server managing and operating the credit card). The issuer of the credit card then executes settlement processing.

In Step S2360, the processor 210A receives an order for the goods in the real space corresponding to the goods object purchased by the user 5A. For example, when the user 5A has purchased the light stick object 7A, the processor 210A receives an order for a light stick. More specifically, the processor 210A transmits the user ID of the user 5A and the object ID of the purchased goods object to the server 600. The processor 610 of the server 600 accesses the user DB 1855, and acquires the address corresponding to the received user ID. The processor 610 transmits the obtained address and information (e.g., object ID) identifying the goods object to a server (e.g., external device 700) managed by the promoter of the event. In this way, the promoter of the event transmits the goods corresponding to the goods object to the received address.

With the configuration described above, the user 5A may increase his or her feelings toward the performer of the event by using and visually recognizing goods in the real space. As a result, the promoter of the event can increase the possibility of inviting the user 5A to other events performed by the performer.

In Step S2365, the processor 210A arranges the purchased goods object in the virtual space 11A. More specifically, the processor 610 of the server 600 refers to the object DB 1854, and transmits to the computer 200A the rendering data of the goods object corresponding to the object ID received in Step S2360. The processor 210A arranges the goods object in the virtual space 11A based on the received rendering data. At this time, the processor 210A arranges the goods object in association with the avatar object 6A. For example, the processor 210A arranges a light stick object in association with the hand object 1643.

In Step S2370, the processor 210A detects the motion of the user 5A. For example, the processor 210A detects the position of the hand of the user 5A based on the position information on the controller 300 input from the HMD sensor 410.

In Step S2375, the processor 210A moves the avatar object 6A in association with the motion of the user 5A. As a result, the goods object associated with the avatar object 6A also moves in association with the motion of the user 5A.

In Step S2380, the processor 210A determines whether the event has ended. For example, when the processor 210A receives from the external device 700A signal notifying the end of the event, the processor 210A determines that the event has ended. When the processor 210A determines that the event has ended (YES in Step S2380), the processor 210A ends the series of processing steps. Otherwise (NO in Step S2380), the processor 210A again executes the processing of Step S2330.

(Other Methods of Recommending Goods Object)

In the example described above, the processor 210A recommends a goods object corresponding to the performance to the user 5A at the timing at which the performance is displayed in the virtual space 11A. This prevents the user 5A from feeling a sense of irritation due to a recommendation of a goods object unrelated to the performance.

In at least one aspect, when the level of enthusiasm of the user 5A exceeds a threshold determined in advance, the processor 210A prompts the user 5A to prepare the goods object to be in a usable state in the virtual space 11A by the user 5A. In general, when people are more excited, they will buy more. Therefore, the processor 210A may increase the probability that the user 5A purchases a goods object by recommending the goods object to the user 5A at a timing when the user 5A is enthusiastic about the event.

In at least one aspect, the processor 210A changes the type of goods object to be recommended to the user 5A in accordance with the level of enthusiasm of the user 5A. For example, the processor 210A may be configured to recommend a more expensive goods object to the user 5A when the level of enthusiasm of the user 5A is higher.

In at least one aspect, when a designation by the user 5A for a goods object associated with an avatar object is received, the processor 210A recommends that goods object to the user 5A. For example, the user 5A designates a light stick object by superimposing the pointer object 2265 on the light stick object 7B associated with the avatar object 6B for a predetermined period of time (e.g., 2 seconds). As another example, the user 5A designates a light stick object by superimposing a light beam extending from the tip of the hand object 1643 on the light stick object 7B for a predetermined time. As yet another example, the user 5A designates a light stick object by causing the hand object 1643 to touch the light stick object 7B.

With the configuration described above, the processor 210A can recommend a goods object to the user 5A at a timing at which the user 5A is expressing an interest in a goods object being used by another person (including a non-player character). As a result, the processor 210A may increase the probability that the user 5A purchases the goods object.

[User Analysis]

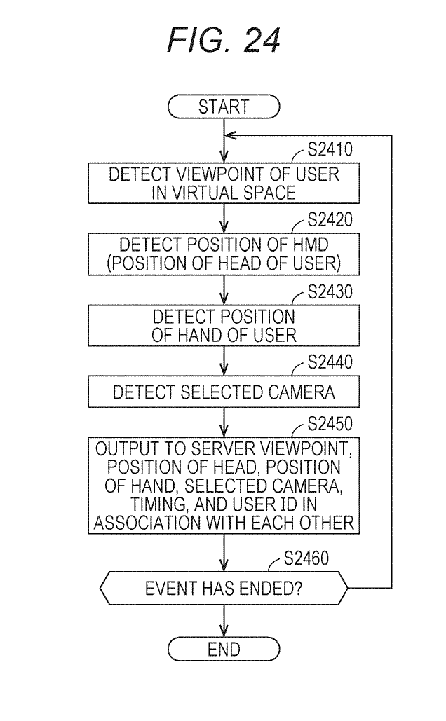

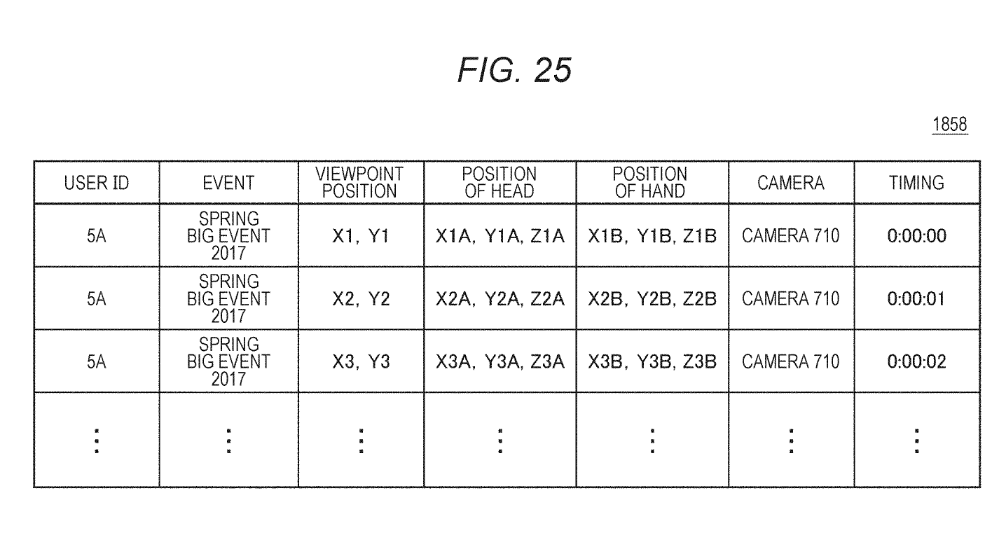

Next, a configuration for analyzing the user 5A by the server 600 is described with reference to FIG. 24 and FIG. 25. FIG. 24 is a flowchart of processing in which the processor 210A transmits data on the user 5A who is viewing an event to the server 600 according to at least one embodiment of this disclosure. The processing of FIG. 24 is executed when a video of an event is displayed in the virtual space 11A.

In Step S2410, the processor 210A detects the viewpoint (e.g., position of pointer object 2265) of the user 5A in the virtual space 11A. As an example, the processor 210A detects the position of the viewpoint of the user 5A in the main screen 1541.

In Step S2420, the processor 210A detects the position of the HMD 120A, that is, the position of the head of the user 5A. In Step S2430, the processor 210A detects the position of the controller 300A, that is, the position of the hand of the user 5A. In Step S2440, the processor 210A detects the camera (i.e., standpoint of selected video) corresponding to the video currently selected by the user 5A (video displayed on the main screen 1541).

In Step S2450, the processor 210A transmits to the server 600 the various data detected in Step S2410 to Step S2440, the user ID of the user 5A, and the time (timing) that has elapsed from the start of the event to the present in association with one another.

In Step S2460, the processor 210A determines whether the event has ended. For example, when the processor 210A receives from the external device 700A a signal indicating that the event has ended, the processor 210A determines that the event has ended. The processor 210A periodically (e.g., every 1 second) repeats the processing of Step S2410 to Step S2450 until it is determined that the event has ended.

In at least one aspect, the processor 210A transmits to the server 600 at least one piece of data among the various data detected in Step S2410 to Step S2440. The processor 210A may also transmit a character string extracted from a sound signal input from the microphone 119A, an amplitude value of that sound signal, and the like to the server 600.

(Viewing History DB 1858)

FIG. 25 is a table of an example of a data structure of the viewing history DB 1858 according to at least one embodiment of this disclosure. Referring to FIG. 25, the viewing history DB 1858 stores a user ID, information identifying an event, a viewpoint position, a head position, a hand position, information identifying a camera (i.e., information identifying standpoint) and a timing. Except for the information identifying an event, the other data corresponds to the data received from the computer 200A in Step S2450. In the example of FIG. 25, the reason why the viewpoint position is expressed as two-dimensional information is because the viewpoint position represents the viewpoint position of the user 5A on the main screen 1541.

Among the data stored in the viewing history DB 1858, the server 600 provides to the promoter of an event the data corresponding to that event. As a result, the promoter of the event can grasp the actions of the users regarding the event. More specifically, the promoter is able to understand “what” the users were watching the event at “which time” and in “what manner”. The promoter can grasp the camerawork the users like.

Users participating in an event performed in the real space do not have sensors. Therefore, in the past, it has been difficult for the promoter to grasp the actions of users participating in the event. In contrast, users participating in events performed in the virtual space have various sensors. Therefore, the promoter can grasp the actions of the users participating in the event in the manner described above. As a result, the promoter is able to analyze the actions of the users and provide events tailored to the user preferences.

[Recommending to User Moving Image Visually Recognized by User]

As described above, while viewing an event, the user 5A selects any one of the subscreens 2261 to 2264 as appropriate to switch the video displayed on the main screen 1541.

The user 5A may wish to see an event he or she has already seen again. Therefore, in at least one aspect, the server 600 distributes to the computer 200A the video (hereinafter also referred to as “main video”) displayed on the main screen 1541.

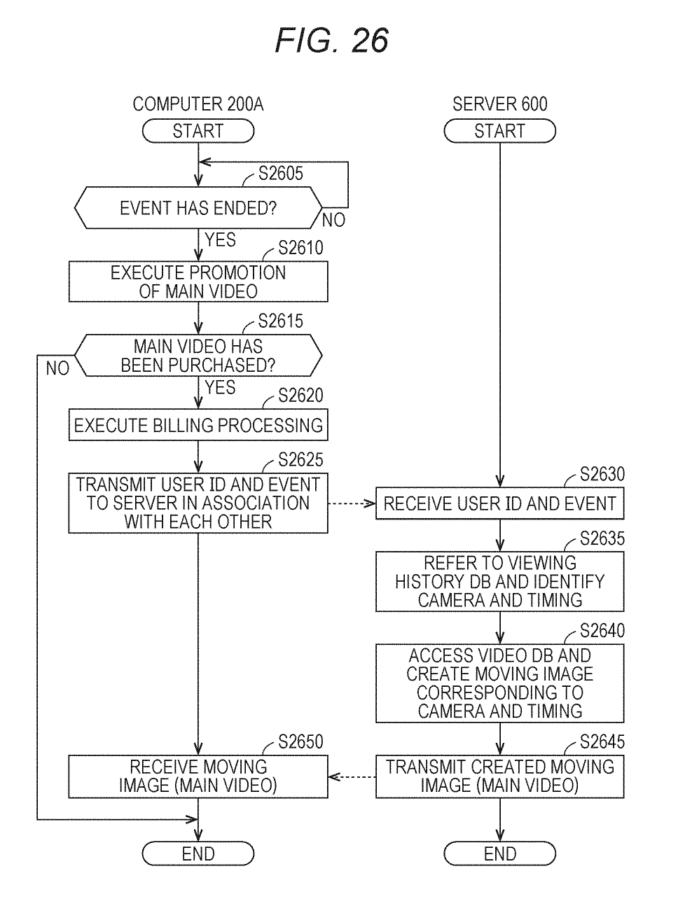

There is now described a method of distributing a specific main video with reference to FIG. 26. FIG. 26 is a flowchart of processing in which the server 600 distributes a main video to the computer 200A according to at least one embodiment of this disclosure.

In Step S2605, the processor 210A determines whether the event has ended. When it is determined that the event has ended, the processor 210A executes the processing of Step S2610.

In Step S2610, the processor 210A executes promotion of the main video. For example, in the same manner as the above-mentioned popup 1645, the processor 210A arranges in the virtual space 11A a popup asking the user 5A whether he or she wishes to purchase the main video.

In Step S2615, the processor 210A determines whether the user 5A wishes to purchase the main video. More specifically, the processor 210A performs this determination based on a response input by the user 5A in response to the inquiry in Step S2610. When it is determined that the user 5A wishes to purchase the main video (YES in Step S2615), the processor 210A executes the processing of Step S2620. Otherwise (NO in Step S2615), the processor 210A ends the series of processing steps.

In Step S2620, the processor 210A executes processing of billing the user 5A for the cost of the main video. This processing is the same as the processing described above for Step S2355, and hence a description thereof is not repeated.

In Step S2625, the processor 210A transmits the user ID of the user 5A and information identifying the event to the server 600 in association with each other. In Step S2630, the processor 610 of the server 600 receives those pieces of information.

In Step S2635, the processor 610 accesses the viewing history DB 1858, and acquires the timing corresponding to the received user ID and the information identifying the event, and information identifying the cameras. In Step S2640, the processor 610 accesses the video DB 1856, and acquires a plurality of pieces of video data corresponding to the event. The processor 610 also creates a main video based on the acquired plurality of pieces of video data, the timing, and the information identifying the cameras.

In Step S2645, the processor 610 transmits the created main video to the computer 200A. In Step S2650, the processor 210A receives the main video from the server 600.

With the configuration described above, the user 5A can again view the video (main video) of the event he or she saw.

[Control of Non-Player Character]

Next, a method of controlling motion of a non-player character (hereinafter also referred to as “NPC”) avatar object is described. For example, when the number of avatar objects present in the virtual space 11A is small, it may be difficult for the user 5A to feel a sense of togetherness with the other audience members.

Therefore, when the number of avatar objects corresponding to other users is less than a predetermined target value, the processor 210A arranges in the virtual space 11A NPCs (avatar objects) corresponding to the difference from the target value. The target value may be set to, for example, a larger value when the virtual space 11A is larger.

When all the NPCs arranged in the virtual space 11A perform the same motion, the user 5A may feel a sense of unease. This is because it is impossible for users participating in an event in the real space to perform exactly the same motion. Therefore, in at least one embodiment, the processor 210A performs control such that a plurality of NPCs are classified into a plurality of groups (e.g., three groups) and different motions are performed for each group. For example, the NPCs are classified such that that adjacent NPCs belong to different groups, which makes it more difficult for the user 5A to notice that the NPCs are performing the same motion. This also enables the processor 210A to control the motion of the NPCs with a lower processing load than when performing control such that each of the plurality of NPCs performs a different motion.

There are cases in which the participants perform a fixed motion in accordance with the performance. For example, in a specific song, participants at the event may swing to left and right. In such a case, when the NPCs do not perform the same motion as the participants, the user 5A may feel a sense of unease. This is because the motion of the avatar objects of the other users and the motion of the participants displayed on the screen are different from the motion of the NPCs. The motion of the NPCs that is different from the motion of the other audience members may harm the atmosphere of the event. For example, when the NPCs are vigorously moving while other audience members (including avatar objects of other users) are moving slowly in time with a ballad song, there is a possibility that the impression of the user 5A regarding the event (performance) is diminished.

Therefore, in at least one aspect, the processor 210A controls the motion of NPC in accordance with the performance. For example, the computer 200A receives from the server 600 a list of performances in the event and the genre of each of the performances (e.g., ballad and rock). Those pieces of information are registered in the server 600 in advance by the promoter. The processor 210A controls the motion of the NPCs in accordance with the genre of the performance. With this configuration, the HMD set 110A may suppress the user 5A from feeling a sense of unease about the motion of the NPCs.

In at least one aspect, when the user 5A views an event already performed, the processor 210A translates the motion of another past user (motion of avatar object) corresponding to the performance in the NPCs.

(Processing of Translating Motion of Other Users in NPCs)

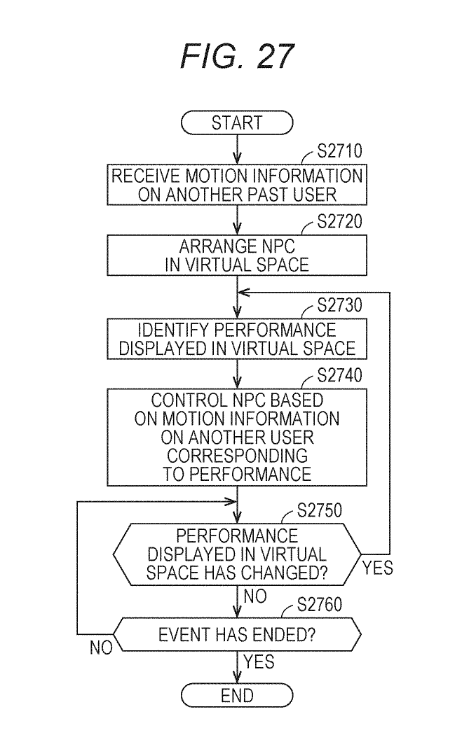

FIG. 27 is a flowchart of processing of translating motion of another past user in NPCs according to at least one embodiment of this disclosure. The processing of FIG. 27 is executed in response to input to the processor 210A by the user 5A of an instruction to view an already performed event.

In Step S2710, the processor 210A receives from the server 600 motion information on another past user. More specifically, when an instruction to view an already performed event is received from the user 5A, the processor 210A transmits information identifying the event to the server 600. The server 600 accesses the viewing history DB 1858, and transmits information on the timing, head position, and hand position corresponding to the event to the computer 200A.

In Step S2720, the processor 210A arranges one or more NPCs in the virtual space 11A. In Step S2730, the processor 210A identifies the performance corresponding to the video displayed in the virtual space 11A. For example, the computer 200A receives from the server 600 in advance a table storing a relationship between “performances” from the server 600 and the timing at which the performances are performed in the event. The processor 210A identifies the performances based on the elapsed time from the start of the event and the table.

In Step S2740, the processor 210A identifies, among the motion information on the another user received in Step S2710, the motion information on another user corresponding to the identified performance. The processor 210A translates the identified motion information on the another user in the NPCs. At that time, the processor 210A classifies the arranged NPCs into a plurality of groups (e.g., three groups), and translates the motion information on different users for each group.

In Step S2750, the processor 210A determines whether the performance displayed in the virtual space has changed. When the processor 210A determines that the performance has changed (YES in Step S2750), the processor 210A executes the processing of Step S2730 again. Otherwise (NO in Step S2750), the processor 210A determines whether the event has ended (Step S2760). When the processor 210A determines that the event has ended (YES in Step S2760), the processor 210A ends the series of processing steps. Otherwise (NO in Step S2760), the processor 210A executes the processing of Step S2750 again.

With the processing described above, in at least one embodiment, the HMD set 110A is capable of suppressing the user 5A from feeling a sense of unease with the motion of the NPCs to a much greater level by translating the motion of another user in the NPCs. The user 5A can feel a much greater sense of togetherness with the other audience members (including NPCs) by performing the same motion as the NPCs and the participants displayed on the screen.

In the example described above, when the user 5A participates in the already performed event, processing of translating the motion of another user in the NPCs is performed. However, the motion of another user may be translated in the NPCs even in the case of streaming the event in virtual space. For example, the server 600 collects information representing the motion of each of a plurality of users for a predetermined period of time (e.g., 10 seconds) at the timing when the performance switches, and transmits the information to the computer 200A. The processor 210A translates the information received from the server 600 in the NPCs. With this configuration, even when the user 5A views the streamed event in the virtual space 11A, the user 5A is less likely to feel a sense of unease about the NPCs.

[Event Corresponding to Level of Enthusiasm]

FIG. 28 is a diagram of a method of calculating a level of enthusiasm according to at least one embodiment of this disclosure. In at least one aspect, the user 5A visually recognizes a field-of-view image 2817 of FIG. 28.

Referring to FIG. 28, the light stick object 7A is associated with the hand object 1643. Under this state, the user 5A swings the right controller 300 from the back to the front. The processor 210A moves the hand object 1643 and the light stick object 7A in the direction of an arrow 2865 based on input from the right controller 300 (or HMD sensor 410). In conjunction with this, the processor 210A arranges an enthusiasm object 2866 at the tip of the light stick object 7A and moves the enthusiasm object 2866 in the direction of the arrow 2865. When the enthusiasm object 2866 touches the main screen 1541, the processor 210A transmits that fact and the user ID of the user 5A to the server 600.

When the server 600 receives the information from the computer 200A, the server 600 increments a count value set for the user ID of the user 5A. This count value represents the level of enthusiasm. The server 600 transmits the total value of the count values of all the users participating in the event in the virtual space to the respective computers of those users (hereinafter also referred to as “total count value”). The server 600 also transmits a ranking of the count values of each user ID to the corresponding computer.

The processor 210A of the computer 200A displays a meter 2867 included in the field-of-view image 2817 and a rank 2868 based on the information received from the server 600. The meter 2867 visually represents the total count value. The rank 2868 represents the ranking of the count value of the user 5A among the people participating in the event in the virtual space.

The user 5A increases the total count value indicated in the meter 2867 by waving the light stick object together with other users. As a result, the user 5A is able to feel a sense of togetherness with the other users. The user 5A may look at his or her rank 2868 and think of shaking the light stick object 7A more than the other users.

When the total count value reaches a value determined in advance, the server 600 transmits information representing that fact to each computer and sets (initializes) the count value of each user to zero. When the information is received from the server 600, the processor 210A of the computer 200A executes in the virtual space 11A a special effect determined in advance.

FIG. 29 is a diagram of an example of a special effect in the virtual space 11A according to at least one embodiment of this disclosure. In FIG. 29, a dome object 2969 is arranged in a field-of-view image 2917. The dome object 2969 is arranged so as to make it appear as if an explosion was occurring in the virtual space 11A in accordance with the total count value reaching a value determined in advance. Because the special effect is performed in accordance with the total count value, the user 5A may feel a sense of togetherness and achievement with the other users.

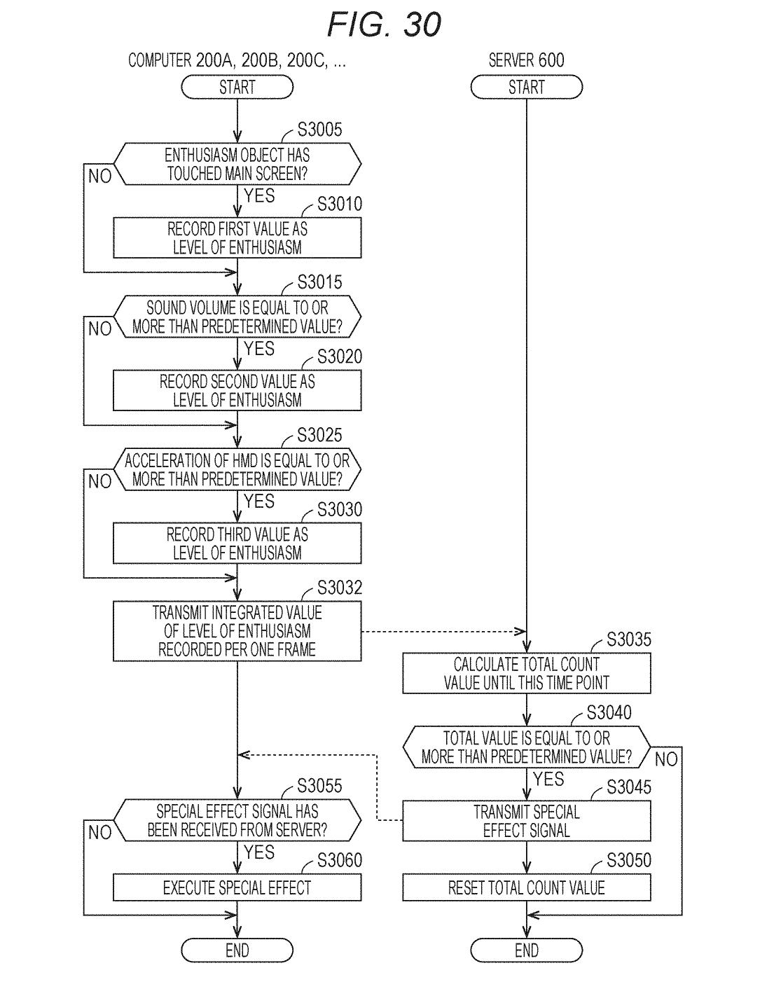

In the example described above, there is described a condition for performing a special effect based on the number of times the enthusiasm object and the main screen have touched. However, the condition under which the special effect is performed is not limited thereto. There is now described another condition for performing the special effect with reference to FIG. 30.

FIG. 30 is a flowchart of processing of executing a special effect in accordance with a level of enthusiasm according to at least one embodiment of this disclosure. The processing of FIG. 30 is implemented every frame (e.g., 30 times per second) by each computer providing a virtual space including an event and the server 600. There is now described, as an example, the processing by the computer 200A and the server 600.

In Step S3005, the processor 210A determines whether the enthusiasm object 2866 and the main screen 1541 have touched. When it is determined that the enthusiasm object 2866 and the main screen 1541 have touched (YES in Step S3005), the processor 210A records a first value as the level of enthusiasm (Step S3010).

In Step S3015, the processor 210A determines whether the amplitude (sound volume) of the sound signal input from the microphone 170A is equal to or more than a predetermined value. When it is determined that the sound volume is equal to or more than the predetermined value (YES in Step S3015), the processor 210A records a second value as the level of enthusiasm (Step S3020).

In Step S3025, the processor 210A determines whether the acceleration of the HMD 120A (acceleration of head of user 5A) is equal to or more than a predetermined value. For example, the processor 210A performs this determination by calculating the acceleration of the HMD 120A based on output of the sensor 190. When the acceleration of the HMD 120A is equal to or more than the predetermined value (YES in Step S3025), the processor 210A records a third value as the level of enthusiasm (Step S3030).

In Step S3032, the processor 210A calculates an integrated value of the values recorded per one frame based on the results of Step S3005 to Step S3030, and transmits the calculation result to the server 600.

In Step S3035, the processor 610 of the server 600 adds the integrated value received from each computer 200 to the total count value calculated so far. As a result, the total count value at the present point in time is calculated.

In Step S3040, the processor 610 determines whether the calculated total count value has reached a predetermined value. When it is determined that the total count value has reached the predetermined value (YES in Step S3040), the processor 610 transmits a special effect signal to each computer 200 (Step S3045), and then resets the total count value (Step S3050). Otherwise (NO in Step S3040), the processor 610 ends the series of processing steps.

In Step S3055, the processor 210A determines whether the special effect signal has been received from the server 600. When it is determined that the special effect signal has been received (YES in Step S3055), the processor 210A executes in the virtual space 11A a special effect determined in advance. Otherwise (NO in Step S3055), the processor 210A ends the series of processing steps.

As described above, the processor 210A may determine whether to execute the special effect by calculating the level of enthusiasm (count value) in consideration of elements other than the number of times the enthusiasm object 2866 and the main screen 1541 have touched.

[Configurations]

The technical features disclosed above are summarized in the following manner.

(Configuration 1)

According to at least one embodiment, there is provided a program to be executed by a computer 200A to provide a virtual space 11A by an HMD 120. This program causes the computer 200A to execute: defining the virtual space 11A (Step S2305); receiving input of a video obtained by photographing an event performed in a real space from a server 600 or an external device 700 (Step S2320); displaying the input video in the virtual space 11A (Step S2325); and prompting a user 5A to prepare a goods object (e.g., light stick object 7A) corresponding to goods to be used in the event so as to enable the user 5A of the HMD 120A to use the goods object in the virtual space 11A (Step S2345).

With the configuration described above, the user 5A is able to use in the virtual space goods to be used in the event. This enables the HMD set 110A to enhance the sense of participation of the user 5A in the event. The goods may also be used by other audience members present in real space and in the virtual space. As a result, the user 5A is able to feel a sense of togetherness with other audience members by using the goods.

(Configuration 2)

In Configuration 1, the event includes one or more performances. In at least one performance out of the one or more performances, goods corresponding to the performance are used. The prompting includes prompting the user 5A to prepare the goods object corresponding to the goods matching the performance displayed in the virtual space 11A so as to enable the user 5 to use the goods object in the virtual space 11A (Step S2345).

In at least one aspect, a performer of the event may prompt audience members to use goods corresponding to the performance. With the configuration described above, the HMD set 110A may further enhance the sense of participation of the user 5A in the event and the togetherness with the other audience members and the performer by prompting the user 5A to use goods corresponding to the performance. The user 5A is recommended to use the goods at an appropriate timing (timing corresponding to the performance), and hence a sense of unease regarding the recommendation is less likely to occur.

(Configuration 3)

The program according to Configuration 1 or Configuration 2 further causes the computer 200A to execute billing of the user 5A in accordance with input by the user 5A in response to the prompting (Step S2350 to Step S2355).

(Configuration 4)

The program according to Configuration 3 further causes the computer 200A to execute calculating a level of interest of the user 5A in the event (Step S2335). The billing of the user includes billing the user 5A for an amount of money corresponding to the detected level of interest (Step S2340).

(Configuration 5)

The program according to anyone of Configurations 1 to 4 further causes the computer 200A to execute receiving an order for goods in the real space corresponding to a goods object in accordance with input by the user 5A in response to the prompting (Step S2360).

With the configuration described above, the user 5A may increase his or her feelings for the performer of the event by using and visually recognizing goods in the real space. As a result, the promoter of the event may increase the possibility of inviting the user 5A to other events performed by the performer.

(Configuration 6)

In any one of Configurations 1 to 5, the prompting includes prompting the user 5A to prepare the goods object so as to enable the user 5A to use the goods object before a time determined in advance from a timing at which the performance in which the goods object is to be used is displayed in the virtual space 11A.

With the configuration described above, the HMD set 110A is able to prompt the user 5A to use the goods object before the performance starts. As a result, the user 5A is able to concentrate more on the performance, and is thus able to enjoy the event more.

(Configuration 7)

In any one of Configurations 1 to 6, the prompting includes arranging in the virtual space 11A a popup 1645 including the goods object.

(Configuration 8)

The program according to anyone of Configurations 1 to 7 further causes the computer 200A to execute detecting a level of interest of the user 5A in the event (Step S2335). The prompting includes prompting the user 5 to prepare the goods object so as to enable the user 5 to use the goods object in the virtual space 11A based on the detected level of interest.

With the configuration described above, the HMD set 110A is able to recommend use of the goods object to the user 5A when the user 5A is in an excited state. As a result, the HMD set 110A is able to increase the possibility of the user using the goods object.

(Configuration 9)

In Configuration 8, the prompting includes prompting the user 5 to prepare goods object corresponding to the detected level of interest so as to enable the user 5A to use the goods object in the virtual space 11A.

With the configuration described above, the user 5A is able to take actions to increase his or her level of interest in the event. As a result, the user 5A is able to enjoy the event more.

(Configuration 10)

The program according to any one of Configurations 1 to 9 further causes the computer 200A to execute: arranging avatar objects (e.g., avatar objects 6B and 6N) in the virtual space 11A (Step S2315); and prompting the user 5A to prepare the goods object so as to enable the user 5A to use the goods object based on receiving of a designation by the user 5A of a goods object associated with the avatar objects. For example, the program receives the designation as a result of the user 5A viewing a goods object associated with (used by) an avatar object for a predetermined period of time.

With the configuration described above, the user 5A receives a recommendation of a goods object at the timing at which he or she expresses an interest in the goods object. In this way, the user 5A is recommended to use the goods at an appropriate timing, and hence the user 5A is less likely to feel a sense of unease at the recommendation.

(Configuration 11)

In any one of Configurations 1 to 10, the program further causes the computer 200A to execute: arranging one or more NPCs in the virtual space 11A (Step S2720); and controlling a motion of each NPC in accordance with the performance displayed in the virtual space 11A (Step S2730).

With the configuration described above, HMD set 110A is able to translate a natural motion corresponding to the performance in the NPCs. This enables the HMD set 110A to reduce a difference between the motion of the NPCs and the motion of the avatar objects corresponding to the other audience members. As a result, the user 5A is less likely to feel a sense of unease with the NPCs and can concentrate more on the event.

(Configuration 12)

In Configuration 11, the program further causes the computer 200A to execute receiving input of data representing a motion of another user 5B different from the user 5A regarding a first performance among one or more performances (Step S2710). The controlling of the motion of each NPC includes controlling the motion of the NPCs based on the data input during at least a portion of a period in which the first performance is displayed in the virtual space 11A.

With the configuration described above, the HMD set 110A is able to translate a motion of a past user in the NPCs, which enables a more natural motion of the NPCs to be realized. It is also no longer required for the HMD set 110A to prepare motion data for the NPCs corresponding to the performance in advance.

(Configuration 13)

In Configuration 11 or 12, the program further causes the computer 200A to execute: detecting the level of interest of the user 5A in the event (Step S3005 to Step S3030); receiving the detected level of interest of the user 5A to the server 600 (Step S3032); transmitting from the server 600 a special effect signal from the server 600 indicating that a condition determined in advance based on the level of interest of the user 5A and the level of interest in the event of another user different from the user 5A is satisfied (Step S3055); and executing a special effect determined in advance in the virtual space 11A when the special effect signal is received (Step S3060).

With the configuration described above, the user 5A can cooperate with other audience members (users) to cause a special effect. Therefore, the user 5A can feel a sense of togetherness with the other audience members.

(Configuration 14)

The receiving of the input of the video according to any one of Configurations 1 to 13 includes receiving input of a plurality of videos obtained by photographing the event with cameras 710 to 174 arranged at a plurality of standpoints. The displaying of the video in the virtual space 11A includes: displaying the plurality of videos on a plurality of subscreens 2261 to 1940 arranged in the virtual space 11A; receiving from the user 5A input of a selection of any one of the plurality of subscreens 2261 to 1940; and displaying the video corresponding to the selected subscreen on a main screen 1541 larger than the subscreens arranged in the virtual space 11A.

With the configuration described above, the user 5A can view the video he or she is interested in on a large screen.

(Configuration 15)

In Configuration 14, the program further causes the computer 200A to execute receiving from the server 600 the video displayed on the main screen 1541 (Step S2650).

With the configuration described above, the user 5A can again view the video (main video) of the event he or she was watching at a desired timing.

(Configuration 16)

In Configuration 15, the program further causes the computer 200A to execute billing of the user 5A in response to the receiving of the video displayed on the main screen 1541 (Step S2620).

(Configuration 17)

In Configurations 1 to 16, the program further causes the computer 200A to execute: detecting a viewpoint of the user 5A in the virtual space 11A (Step S2410); and outputting to the server 600 the timing and the viewpoint in the event in association with each other (Step S2450).

With the configuration described above, the promoter of the event can grasp the timing and the type of content the user 5A expressed an interest in the event.

(Configuration 18)

In Configuration 17, the program further causes the computer 200A to execute detecting the motion of the user 5A (Step S2420 to Step S2430). The outputting includes outputting to the server 600 the viewpoint, the timing, and the motion of the user 5A corresponding to the timing in association with one another (Step S2450).

With the configuration described above, the promoter of the event can grasp what actions the user 5A was doing, and when the user 5A was doing those actions during the event.

(Configuration 19)

The receiving of the input of the video in Configuration 17 or 18 includes receiving input of a plurality of videos obtained by photographing an event by cameras 710 to 174 arranged at a plurality of standpoints. The displaying of the video in the virtual space 11A includes: displaying a plurality of videos on a plurality of subscreens 2261 to 1940 arranged in the virtual space 11A; receiving from the user 5A a selection of any one of the plurality of subscreens 2261 to 1940; and displaying on a main screen 1541 the video corresponding to the selected subscreen larger than the subscreens arranged in the virtual space 11A. The program further causes the computer 200A to execute (Step S2440 to Step S2450) outputting to the server 600 a position (i.e., standpoint) at which the video corresponding to the selected subscreen is photographed.

With the configuration described above, the promoter of the event is able to grasp the camerawork preferred by the user 5A.

It is to be understood that the embodiments disclosed herein are merely examples in all aspects and in no way intended to limit this disclosure. The scope of this disclosure is defined by the appended claims and not by the above description, and it is intended that this disclosure encompasses all modifications made within the scope and spirit equivalent to those of the appended claims.

1. A method of providing a virtual space, the method comprising:
defining the virtual space, wherein the virtual space is associated with a first avatar object and a first virtual monitor object, and wherein the first avatar object is associated with a first user;
storing in a memory video content generated by photographing an event in a real space;
storing in the memory information on a first virtual physical object associated with the video content;
reading the video content from the memory and displaying the read video content on the first virtual monitor object;
determining a first field of view of the first user in the virtual space based on a first virtual camera associated with the first avatar object;
displaying a first video corresponding to the first field of view on a head-mounted device of the first user;
arranging in the virtual space the first virtual physical object associated with the video content in response to advancement of processing of displaying the video content on the first virtual monitor object; and
including in the field of view of the first user a notification prompting the first user to use the first virtual physical object in the virtual space.

2. The method according to claim 1,
wherein the video content comprises a plurality of performances progressing along a time series,
wherein the storing of the video content in the memory comprises storing information on a timing at which each of the plurality of performances is to be played back,
wherein the displaying on the first virtual monitor object comprises displaying each performance on the first virtual monitor object in response to arrival of a timing at which each performance of the video content is to be played back,
wherein the storing in the memory of the information on the first virtual physical object comprises storing in the memory the information on the first virtual physical object in association with each of the plurality of performances, and
wherein the arranging of the first virtual physical object comprises arranging, in response to the playing back of each performance of the video content, the first virtual physical object associated with the performance.

3. The method according to claim 1, further comprising:
receiving from the first user a first operation of billing in order to use the first virtual physical object;
associating the first virtual physical object with the first user in response to the receiving of the first operation;
detecting a second operation of the first user; and
moving the first avatar object and the first virtual physical object associated with the first user in accordance with a detection result of the second operation.

4. The method according to claim 3,
wherein the detecting of a second operation comprises detecting a sensor output of any one of a first sensor configured to detect a motion of a line of sight of the first user, a second sensor configured to detect a motion of the head-mounted device of the first user, and a third sensor configured to detect a motion of a hand of the first user,
wherein the method further comprises calculating a first parameter representing a level of interest of the first user in the video content based on a detection result of the sensor output, and
wherein the receiving of a first operation comprises:
determining an amount of money corresponding to the first parameter as a billing amount; and
displaying information on the determined billing amount in the field of view of the first user.

5. The method according to claim 1,
wherein the method further comprises storing in the memory real object information representing a real object associated with the first virtual physical object,
wherein the including of the notification in the field of view of the first user comprises receiving from the first user a third operation of purchasing the real object corresponding to the first virtual physical object, and
wherein the method further comprises receiving, in response to the third operation, order processing of the real object associated with the first virtual physical object.

6. The method according to claim 2, wherein the including of the notification in the field of view of the first user comprises issuing a notification prompting, before arrival of the timing at which each performance of the video content is to be played back, use of the first virtual physical object associated with the performance.

7. The method according to claim 1,
wherein the method further comprises:
detecting a second operation of the first user; and
moving the first virtual physical object associated with the first user in accordance with a detection result of the second operation,
wherein the detecting of the second operation comprises detecting a sensor output of any one of a first sensor configured to detect a motion of a line of sight of the first user, a second sensor configured to detect a motion of the head-mounted device of the first user, and a third sensor configured to detect a motion of a hand of the first user,
wherein the method further comprises calculating a first parameter representing a level of interest of the first user in the video content based on a detection result of the sensor output, and
wherein the including of the notification in the field of view of the first user comprises including the notification in the field of view of the first user when the first parameter satisfies a first condition and avoiding including the notification in the field of view when the first parameter fails to satisfy the first condition.

8. The method according to claim 7,
wherein the storing in the memory of the information on the first virtual physical object comprises storing a first range, which is a range of the first parameter satisfying the first condition, and a second range different from the first range in the memory in association with the first virtual physical object, which is different for the first range and for the second range, and
wherein the including of the notification in the field of view of the first user comprises including in the field of view a notification prompting use of the first virtual physical object associated with the first range to which the first parameter corresponds when the first parameter satisfies the first condition.

9. The method according to claim 2,
wherein the virtual space is further associated with a second avatar object, the second avatar object comprising a non-player character, and
wherein the method further comprises:
storing first motion information representing a motion of the second avatar object in the memory in association with each of the plurality of performances; and
controlling the motion of the second avatar object in the virtual space and moving, in response to arrival of the timing at which each performance of the video content is to be played back, the second avatar object based on the first motion information associated with the performance.

10. The method according to claim 9,
wherein the method further comprises:
detecting a third operation of a second user different from the first user;
moving a third avatar object associated with the second user and a second virtual physical object associated with the second user in accordance with a detection result of the third operation; and
storing in the memory second motion information representing a motion of the third avatar object based on the detection result of the third operation and third motion information representing a motion of the second virtual physical object, and
wherein the controlling of the motion of the second avatar object comprises moving the second avatar object based on the second motion information or the third motion information stored in the memory in association with each performance.

11. The method according to claim 10,
wherein the method further comprises:
detecting a second operation of the first user; and
moving the first avatar object and the first virtual physical object associated with the first user in accordance with a detection result of the second operation,
wherein the detecting of the second operation comprises detecting a sensor output of any one of a first sensor configured to detect a motion of a line of sight of the first user, a second sensor configured to detect a motion of the head-mounted device of the first user, and a third sensor configured to detect a motion of a hand of the first user,
wherein the method further comprises calculating a first parameter representing a level of interest of the first user in the video content based on a detection result of the sensor output,
wherein the detecting of the third operation comprises detecting a sensor output of any one of a fourth sensor configured to detect a motion of a line of sight of the second user, a fifth sensor configured to detect a motion of a head-mounted device of the second user, and a sixth sensor configured to detect a motion of a hand of the second user, and
wherein the method further comprises:
calculating a second parameter representing a level of interest of the second user in the video content based on a detection result of the sensor output;
calculating a third parameter representing a level of interest of both the first user and the second user in the video content based on the first parameter and the second parameter;
storing in the memory a special effect executable in the virtual space when the video content is displayed on the virtual monitor object; and
executing the special effect in the virtual space when the third parameter satisfies a second condition.

12. The method according to claim 1,
wherein the video content comprises a plurality of pieces of sub-video content generated by photographing the event in a real space with a plurality of real cameras,
wherein the virtual space is associated with the plurality of first virtual monitor objects and a second virtual monitor object having a size larger than the plurality of first virtual monitor objects, and
wherein the displaying of the video content comprises:
displaying the plurality of pieces of sub-video content on the plurality of first virtual monitor objects;
receiving a fourth operation on the sub-video content displayed on the plurality of first virtual monitor objects, the fourth operation being a selection operation by the first user; and
displaying the sub-video content selected by the user on the second virtual monitor object in response to the fourth operation.

13. The method according to claim 12,
wherein the method further comprises receiving from the first user a fifth operation of billing to cause the sub-video content to be displayed on the second virtual monitor object, and
wherein the displaying of the sub-video content on the second virtual monitor object comprises performing the display in response to the receiving of the fifth operation.

14. The method according to claim 12, further comprising storing, during playback of the video content by the first virtual monitor object and the second virtual monitor object, in the memory a playback time and information identifying the sub-video content selected by the first user as the video content to be displayed on the second virtual monitor object in association with each other.

15. The method according to claim 1, further comprising:
receiving from the first user a sixth operation for moving the first virtual camera in the virtual space; and
storing, during playback of the video content by the first virtual monitor object, in the memory a playback time and a position of the first virtual camera in the virtual space in association with each other.

16. The method according to claim 15, further comprising:
associating the first virtual physical object with the first user;
detecting a second operation of the first user, wherein the detecting of the second operation comprises detecting a sensor output of any one of a first sensor configured to detect a motion of a line of sight of the first user, a second sensor configured to detect a motion of the head-mounted device of the first user, and a third sensor configured to detect a motion of a hand of the first user,
moving the first avatar object and the first virtual physical object associated with the first user in accordance with a detection result of the second operation; and
storing, during playback of the video content by the first virtual monitor object, in the memory the playback time and a motion of the first avatar object and a motion of the first virtual physical in the virtual space in association with each other.
